(19) United States
(12) Patent Application Publication
(10) Pub. No.: US 2018/0356507 A1
(43) Pub. Date: Dec. 13, 2018

(54) MULTICOPTER WITH RADAR SYSTEM

(71) Applicants: Nidec Corporation, Minami-ku (JP); WGR Co., Ltd., Kyoto-city (JP)

(72) Inventors: Takeshi ICHINOSE, Kyoto (JP); Hiroyuki KAMO, Kyoto (JP); Hideki KIRINO, Kyoto-city (JP); Hideaki KITAMURA, Kyoto (JP)

(21) Appl. No.: 16/053,909

(22) Filed: Aug. 3, 2018

Related U.S. Application Data
(63) Continuation of application No. PCT/JP2017/003789, filed on Feb. 2, 2017.

(30) Foreign Application Priority Data
Feb. 5, 2016 (JP) 2016-020771
May 2, 2016 (JP) 2016-092619
Jul. 15, 2016 (JP) 2016-140348

(51) Int. Cl. G01S 13/536; B64C 39/02; G01S 13/94; G01S 7/03; G01S 7/35

(52) U.S. Cl. CPC G01S 13/536; B64C 39/024; G01S 13/94; G01S 2007/356; G01S 7/354; B64C 2201/024; B64C 2201/141; G01S 7/032

(57) ABSTRACT

A multicopter includes: motors to respectively rotate three or more rotors; and a radar system to transmit and receive a signal wave and detect a target by using the signal wave. An object detection apparatus in the radar system transmits and receives a signal wave to perform a target detecting process. An antenna element is in a position to receive the transmission wave reflected off a rotor (a rotor-originated reflected wave). The signal wave received at the antenna element is inclusive of a target-originated reflected wave reflected off a target and a rotor-originated reflected wave. The apparatus determines whether or not a frequency band satisfying a predefined condition for identifying a frequency peak is contained in a frequency spectrum of the signal wave as received by the antenna element, and determines a peak of a frequency band satisfying the predefined condition to be a frequency of the target-originated reflected wave.

This is a continuation of International Application No. PCT/JP2017/003789, with an international filing date of Feb. 2, 2017, which claims priority of Japanese Patent Application No. 2016-020771, filed on Feb. 5, 2016, Japanese Patent Application No. 2016-092619, filed on May 2, 2016, and Japanese Patent Application No. 2016-140348, filed on Jul. 15, 2016, the entire contents of which are hereby incorporated by reference.

### BACKGROUND

### 1. Technical Field

The present disclosure relates to a multicopter having a radar system mounted therein.

### 2. Description of the Related Art

Use of unmanned multicopters with three or more rotors is becoming increasingly widespread. Unmanned multicopter are used for photography, crop dusting, disaster investigation from the air, for example, and in recent years have been expected as a means for delivering articles. Unmanned aircraft such as unmanned multicopters are also referred to as UAVs (Unmanned Aerial Vehicles).

Some unmanned multicopters fly via autonomous piloting to a destination by utilizing the Global Positioning System (hereinafter referred to as “GPS” in the present specification). However, even by utilizing the GPS, it is still not possible to accomplish flight while avoiding obstacles such as utility poles, power pylons, bridge piers, and so on. Therefore, in recent years, multicopters having a camera(s) mounted thereon have been developed. Such an unmanned multicopter flies so as to avoid obstacles, while identifying any obstacles that may be contained in a video that is captured with the camera through image processing. Alternatively, the operator may remote-control the unmanned multicopter while watching a video that is captured by the camera. See the specification of United States Patent Publication No. 2014/0180914.

### SUMMARY

Even if a multicopter is flown by utilizing a video taken by the camera, accidents of colliding with obstacles may still occur. Particularly in the nighttime, when there is little light, it is difficult to identify objects or structures which do not emit light by themselves (e.g., trees) through the use of a video taken by the camera.

The present disclosure has been made in order to solve the aforementioned problems, and an objective thereof is to provide a multicopter having a radar system mounted therein.

A multicopter according to one implementation of the present disclosure includes: a central housing; three or more rotors placed around the central housing; a plurality of motors to respectively rotate the three or more rotors; and a radar system to transmit and receive a signal wave and detect a target by using the signal wave, wherein, the radar system includes at least one antenna element and an object detection apparatus to transmit the signal wave, and perform a target detecting process by using the signal wave as received by the at least one antenna element; a first antenna element among the at least one antenna element is in a position to receive a rotor-originated reflected wave, the rotor-originated reflected wave being the signal wave transmitted during flight of the multicopter and having been reflected off a first rotor among the three or more rotors; the signal wave as received by the at least one antenna element is inclusive of a target-originated reflected wave reflected off a target and a rotor-originated reflected wave, the rotor-originated reflected wave being the signal wave transmitted during flight of the multicopter and having been reflected off a first rotor among the three or more rotors; and the object detection apparatus determines whether or not a frequency band satisfying a predefined condition for identifying a frequency peak is contained in a frequency spectrum of the signal wave as received by the at least one antenna element, and determines a peak of the frequency band satisfying the predefined condition to be a frequency of the target-originated reflected wave.

According to an illustrative embodiment of the present invention, a multicopter has a radar mounted therein, and performs signal transmission/reception or signal processing while accounting for the influences of signal waves which are reflected off its rotors, whereby a more accurate target detection is made possible.

### BRIEF DESCRIPTION OF THE DRAWINGS

FIG. 1 is an outer perspective view of an exemplary unmanned multicopter 1 according to the present disclosure.

FIG. 2 is a side view of the unmanned multicopter 1.

FIG. 3 is a diagram schematically showing a hardware construction for the unmanned multicopter 1.

FIG. 4 is a diagram showing an internal hardware construction for the unmanned multicopter 1.

FIG. 5 is a block diagram showing an exemplary fundamental construction, mainly with respect to a radar system 10, of the unmanned multicopter 1 according to the present disclosure.

FIG. 6 is an upper plan view of a slot array antenna TA/RA in which 24 slots 112 are arrayed in 6 rows and 4 columns.

FIG. 7 is a partially-enlarged perspective view along one ridge waveguide 122 in FIG. 6.

FIG. 8 is a perspective view schematically showing the slot array antenna TA/RA, illustrated so that the spacing between the first electrically conductive member 110 and the second electrically conductive member 120 is exaggerated for ease of understanding.

FIG. 9 is a cross-sectional view showing the slot array antenna TA/RA through a plane having a normal which is parallel to the direction that the ridge waveguide 122 extends.

FIG. 10 is a diagram showing example dimensions and relative positioning of components of the slot array antenna TA/RA.

FIG. 11 is a perspective view showing an example of a horn antenna TA/RA.

FIG. 12 is a diagram showing a radiation range of signal waves from a transmission antenna TA.

FIG. 13A is a diagram showing a radiation range of signal waves from a transmission antenna TA which includes two kinds of transmission antenna elements with different directivities.

FIG. 13B is a diagram showing a radiation range of signal waves, on the YZ plane, from the two kinds of transmission antenna elements shown in FIG. 13A.

FIG. 14 is a diagram showing mainly a detailed construction of an object detection apparatus 40.

FIG. 15 is a diagram showing change in frequency of a transmission signal which is modulated based on a triangular wave signal that is generated by a triangular wave/CW wave generation circuit 221.

FIG. 16 is a diagram showing a beat frequency fu in an “ascent” period and a beat frequency fd in a “descent” period.

FIG. 17 is a flowchart showing a procedure of processing by the object detection apparatus 40.

FIG. 18 is a diagram showing relative positioning between an antenna TA/RA and a rotor 5.

FIG. 19 is a diagram schematically showing reflected waves originating from a rotor 5.

FIG. 20 is a diagram schematically showing reflected waves originating from a rotor 5 when a transmission antenna TA which includes two kinds of transmission antenna elements with different directivities is used.

FIG. 21 is a frequency spectrum chart showing a relationship between beat signals respectively corresponding to a reflected wave from the rotor 5 and reflected waves from targets, in a radar system 10 which operates by the FMCW method.

FIG. 22 is a flowchart showing a procedure of processing by a reception intensity calculation section 232 of a signal processing circuit 44 according to Embodiment 1.

FIG. 23 is a chart showing example frequency spectra of three beat signals BCW₁ to B_{CW3} which are respectively obtained from continuous waves CW and three reflected waves originating from a rotor(s) 5.

FIG. 24 is a diagram schematically showing, in a construction corresponding to FIG. 19, a moment at which the solid angle of a rotor 5 becomes smallest and the position of the rotor 5 at that point.

FIG. 25 is a diagram schematically showing, in a construction corresponding to FIG. 20, a moment at which the solid angle of a rotor 5 becomes smallest and the position of the rotor 5 at that point.

FIG. 26A is a diagram showing frequency transitions of a beat signal edge E_{CW}.

FIG. 26B is a diagram showing frequency transitions of a beat signal edge E_{CW}.

FIG. 27 is a flowchart showing a procedure of a process of determining signal wave transmission timing by using continuous waves CW.

FIG. 28A is a diagram showing exemplary beat signal waveforms when a frequency modulated continuous wave FMCW is transmitted.

FIG. 28B is a diagram showing an exemplary frequency spectrum obtained by again radiating a frequency modulated continuous wave FMCW 1 millisecond after a given point in time.

FIG. 28C is a diagram showing a computed result Q2 of difference between the frequency spectrum of FIG. 28A and the frequency spectrum of FIG. 28B.

FIG. 29A is a frequency spectrum chart of various beat signals when a rotor 5 within a monitored field of an antenna TA/RA is positioned so as to rotate in a direction of approaching the antenna TA/RA.

FIG. 29B is a frequency spectrum chart of various beat signals when a rotor 5 within a monitored field of an antenna TA/RA is positioned so as to rotate in a direction away from the antenna TA/RA.

FIG. 30 is a flowchart showing a procedure of processing of separating between a reflected wave originating from a rotor 5 and a target-originated reflected wave according to Embodiment 3.

FIG. 31 is a chart showing frequency spectra of three beat signals B_{CW1} to B_{CW3} which are respectively obtained from continuous waves CW and three reflected waves originating from a rotor(s) 5, and a frequency spectrum of a beat signal B_{TG} obtained from a continuous wave CW and a target-originated reflected wave.

FIG. 32 is a diagram showing a relationship between three frequencies f1, f2 and f3.

FIG. 33 is a diagram showing a relationship between synthetic spectra F1 to F3 on a complex plane.

FIG. 34 is a flowchart showing a procedure of processing of relative velocity and distance determination according to Embodiment 4 based on separation between a reflected wave originating from a rotor 5 and a target-originated reflected wave.

FIG. 35 is an outer perspective view of an unmanned multicopter 501 according to an example application of the present disclosure.

FIG. 36 is a diagram showing a construction for an object detection apparatus 41 according to the present example application.

### DETAILED DESCRIPTION

The inventors have considered mounting a radar system on an unmanned multicopter for use in the delivery of articles, for example. Using the mounted radar system to detect an object which is in the surroundings during flight (hereinafter referred to as a “target”) should make it possible to avoid collision between the unmanned multicopter and the target.

The rotors of an unmanned multicopter will considerably affect a target detection process by the radar system. More specifically, when a rotor of the unmanned multicopter comes into the monitored field of the radar system, target detection may be obstructed (results of the inventors' analysis thereof will be described later in detail).

One way of solving such a problem may be to install the radar system at a position which is unaffected by the rotors. However, the position where the radar system can be installed is subject to constraints imposed by the radar system size, the position at which an article for delivery is mounted, and so on.

The inventors have explored methods other than adjusting the positioning of the radar system, thus arriving at an unmanned multicopter which performs a process of detecting a target (i.e., an object in the surroundings) by transmitting/receiving signals at moments when there is little influence of reflection from the rotors, or by removing influences of rotor reflection from the reception wave.

Hereinafter, with reference to the attached drawings, embodiments of the unmanned multicopter according to the present disclosure will be described. This section will be described with respect to the following items, which will be discussed in this order.

1. Appearance of the unmanned multicopter
2. Internal hardware construction and fundamental operation of the unmanned multicopter
3. Reflection of signal waves by a rotor
4. Processing by the radar system (Embodiments 1 to 4)
5. Example applications

In “4. Processing by the radar system”, various processes by an unmanned multicopter according to the present disclosure will be described as embodiments. It is to be understood that the discussions of the appearance, internal hardware, fundamental operation, and variants of the unmanned multicopter are similarly applicable to each embodiment. Note that the present specification does not require the multicopter to be unmanned. Regardless of whether it is unmanned or manned, the technique disclosed in the present specification is applicable to any multicopter having a radar system mounted therein.

### 1. Appearance of the Unmanned Multicopter

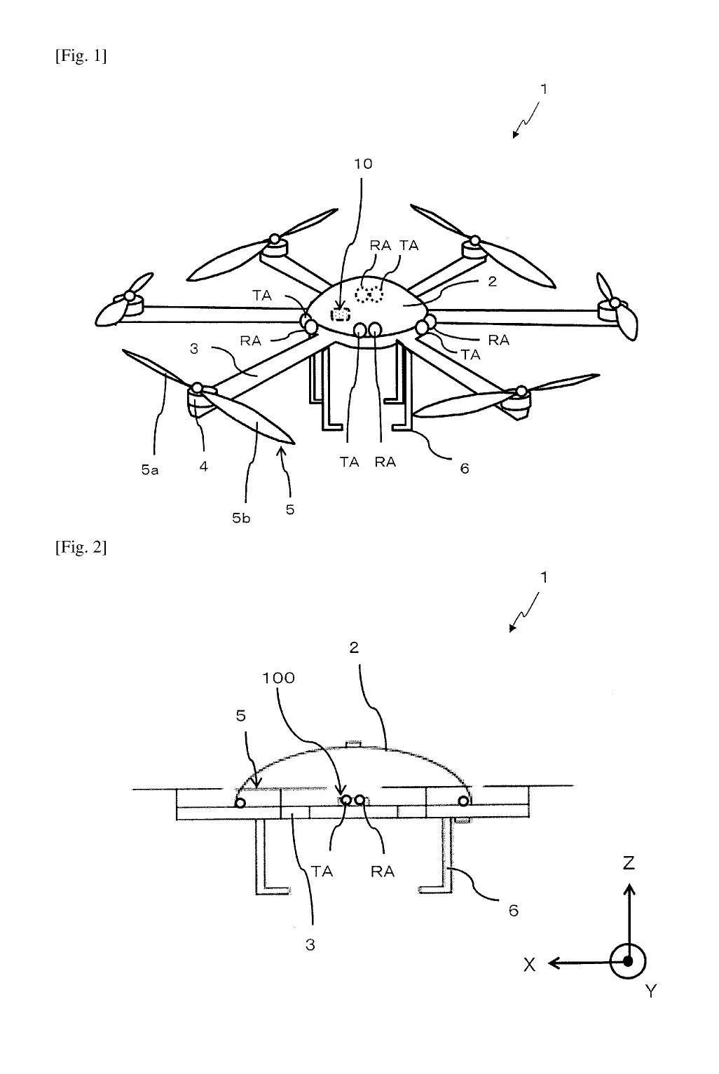

FIG. 1 is an outer perspective view of an exemplary unmanned multicopter 1 according to the present disclosure. FIG. 2 is a side view of the unmanned multicopter 1.

The unmanned multicopter 1 is used to deliver by air an article for delivery that a delivering entity may be entrusted with, for example. By using a radar system 10 and the Global Positioning System (hereinafter referred to as “GPS”), the unmanned multicopter 1 conducts autonomous flight to the destination of delivery. As will be described later, the unmanned multicopter 1 has a function of detecting a target to avoid collision therewith.

The unmanned multicopter 1 includes a central housing 2, and a plurality of arms (as exemplified by an arm 3) extending out from the periphery of the central housing 2, and a plurality of legs (as exemplified by a leg 6) by which an article for delivery is fixed, these legs extending below the central housing 2. Hereinafter, an exemplary construction related to a particular arm 3 will be described; anything that applies to the construction of this arm 3 similarly applies to any other arm.

At the tip end of the arm 3 (i.e., the opposite end from the central housing 2), a motor 4 is provided. A rotor 5 is provided on the axis of rotation of the motor 4. As the motor 4 rotates, the rotor 5 also rotates, thus giving lift for the unmanned multicopter 1. In the present specification, three or more rotors 5 may be provided on a single unmanned multicopter 1.

Each rotor 5 that is attached to a motor 4 includes a plurality of blades 5a and 5b that extend from its axis of rotation. In the present embodiment, the number of blades is preferably two because there being only two blades means less time of interrupting the field of view of the radar system 10. However, there may be three or more blades. From standpoints such as strength, weight, etc., the rotors 5 are preferably made of carbon-fiber-reinforced plastic (CFRP). However, by nature, CFRP is likely to reflect radio waves of the millimeter wave band. Therefore, according to the present disclosure, a process is performed to distinguish signal waves which are reflected by the rotors 5 from signal waves which are received from reception antenna elements, as will be described later.

The radar system 10 is provided in the central housing 2. The radar system 10 according to the present embodiment includes a plurality of sets of a transmission antenna and a reception antenna (of which there may appear six in FIG. 1, for example), each set consisting of one transmission antenna element and four reception antenna elements. The four reception antenna elements in each reception antenna adjoin one another in such a manner that their main lobes are all oriented in the horizontal direction alike, thus constituting one reception antenna array. The reception antenna array is flanked by the transmission antenna element. The main lobe of the transmission antenna element is oriented in the same direction as the main lobe of the reception antenna elements. However, the aforementioned construction is an example. The number of reception antenna elements constituting each reception antenna array is not limited to four; it may be three, or five or more. One or more of the reception antenna elements are to be selected in accordance with the number of targets to be simultaneously detected. Alternatively, transmission and reception of signal waves may be carried out by just one antenna element.

In the case where the transmission antenna element in each transmission antenna includes a plurality of antenna elements, they may respectively have different directivities or the same directivity, as will be described later.

The X axis and the Z axis are defined as shown in FIG. 2, while the Y axis is defined in a direction perpendicular to the plane of the figure. The transmission antenna TA and the rotor 5 are placed relatively close to each other along the Z direction. More specifically, it is assumed in the present disclosure that the rotor 5 exists within the monitored field of the radar system 10. The monitored field of the radar system 10 may, for example, extend in a conical shape having an elliptical cross section, or a pyramidal shape having a square cross section, with the Y axis being its center axis. Note, however, that the conical shape or pyramidal shape as referred to herein does not need to be the exact shape implied by its name.

By utilizing the aforementioned radar system, the unmanned multicopter 1 is able to fly in any direction while avoiding obstacles and the like. When flying in a specific direction, the unmanned multicopter 1 controls its own attitude so that the main lobes of the transmission antenna element and reception antenna elements are oriented in its heading (i.e., direction of flight). During flight, the radar system 10 performs transmission/reception of signal waves regularly, or with arbitrary timing, to detect targets.

Through processes which are described later, the radar system 10 performs signal transmission/reception or signal processing while accounting for the influences of signal waves that are reflected off the rotors. The present specification will mainly describe three processes as follows.

In a first process, the radar system 10 determines whether a reception wave contains a target-originated reflected wave or not (i.e., whether a peak of a target-originated reflected wave can be detected or not). When a peak of a target-originated reflected wave is detected, the radar system 10 performs signal processing for detecting a target by utilizing the peak of the target-originated reflected wave. As used herein, a “target-originated reflected wave” refers to a signal wave that has been reflected off a target and received. A signal wave which has been reflected off a rotor 5 and received will be referred to as a “reflected wave originating from a rotor 5”. Both are reflected waves of a transmitted signal wave.

In a second process, the radar system 10 transmits a signal wave at a moment when the angle or solid angle as viewing the rotor 5 from the antenna element of the transmission antenna TA has a predetermined value or smaller. As one example, the “angle” may refer to an angle on the XY plane in FIG. 2, and the “solid angle” may refer to an angle defined in the XYZ space of FIG. 2. The “predetermined value or smaller” may typically imply the minimum value. For example, in the case of an “angle”, it may be defined as an angle of n/4 or smaller, or 0.78 radians or smaller; in the case of a “solid angle”, it may be defined as an angle of ⅕ steradians or smaller, etc.

In a third process, the radar system 10 performs signal processing to separate between reflected waves originating from a rotor(s) 5 and target-originated reflected waves, and detect a target by utilizing a target-originated reflected wave.

Through any of the above process, the radar system 10 is able to detect a target, and output information of the distance to that target and of the relative velocity between the unmanned multicopter 1 and the target.

Although the central housing is illustrated as a hemispherical shape in the figures, this is an example. Other than this, any shape that is based on a spherical shape, a cylindrical shape, a cubic shape, a pyramidal shape, or a rectangular solid shape may be adopted. Instead of the arms 3, a ring(s), a frame(s), or a beam(s) may be provided to which the plurality of motors 4 and rotors 5 are attached. In either implementation, the arms (e.g., 3), the ring(s), frame(s), or beam(s) may be fixed to the central housing 2.

### 2. Internal Hardware Construction and Fundamental Operation of the Unmanned Multicopter

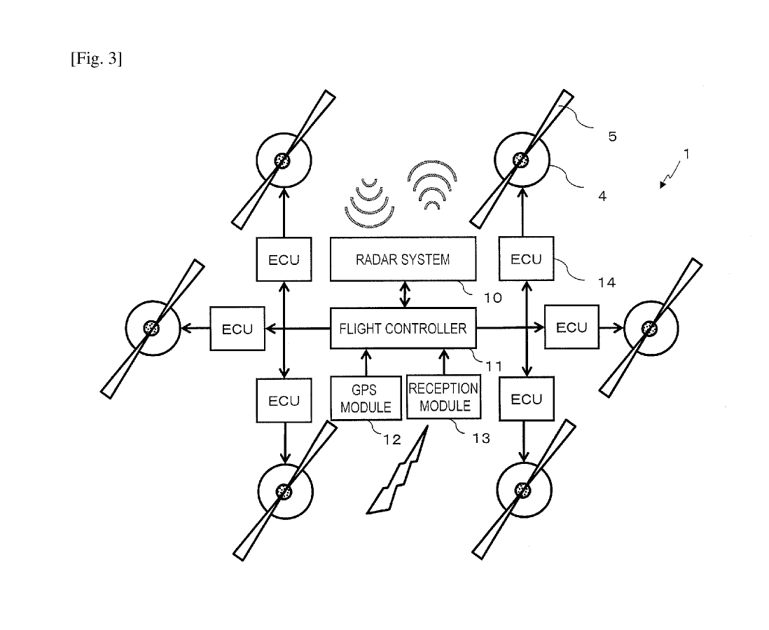

FIG. 3 schematically shows a hardware construction for the unmanned multicopter 1.

The unmanned multicopter 1 includes the radar system 10, a flight controller 11, a GPS module 12, a reception module 13, and electronic control units 14 (ECUs 14). Among these, the flight controller 11 controls the operation of the unmanned multicopter 1. The flight controller 11 receives information and/or manipulation signals from the radar system 10, the GPS module 12, and the reception module 13, subjects them to predetermined processing in order to conduct flight, and outputs a control signal to each ECU 14.

Each ECU 14 controls rotation of the motor 4 based on the control signal. By controlling rotation of all of the motors 4, the flight controller 11 can cause the unmanned multicopter 1 to move forward, move backward, circle, stay still in the air, or move up or down. In causing the unmanned multicopter 1 to move forward or move backward, the attitude of the unmanned multicopter 1 may be controlled so that it is leaning forward or leaning backward. As an implementation of rotational control for the motor 4, PMW (Pulse Width Modulation) may be utilized, for example. In this case, each ECU 14 controls the power to be supplied to the motor 4 by altering the PWM duty ratio.

Hereinafter, the flight controller 11 will be described first, and then the radar system 10. The other constituent elements will be described in conjunction with the flight controller 11 and the radar system 10.

### 2.1. Flight Controller

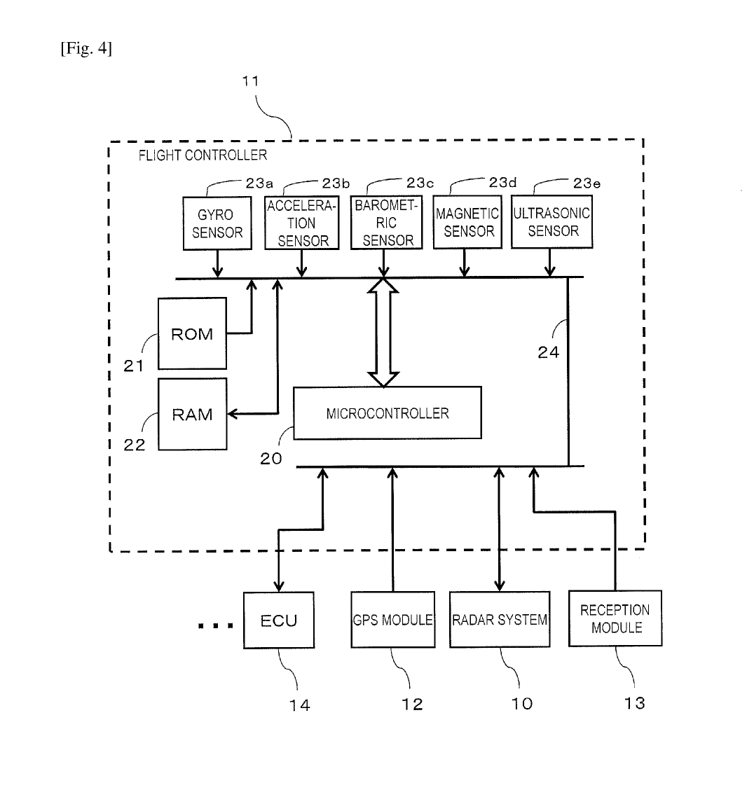

FIG. 4 shows an internal hardware construction for the unmanned multicopter 1.

The flight controller 11 includes a microcontroller 20, a ROM 21, a RAM 22, and a sensor group, which are interconnected via an internal bus 24 so as to be capable of communicating with one another. Via a communication interface not shown, the flight controller 11 is connected to the radar system 10, the GPS module 12, the reception module 13, and the plurality of ECUs 14. A data signal which is input via the communication interface is transmitted inside the flight controller 11 via the internal bus 24, and acquired by the microcontroller 20. Hereinafter, this will be described more specifically. Note that processing by the microcontroller 20 is realized as a computer program which is stored in the ROM 21 and laid out on the RAM 22 is executed by the microcontroller 20.

The microcontroller 20 acquires signals that have been detected by the sensor group. The sensor group may include, for example, a three-axis gyro sensor 23a, a three-axis acceleration sensor 23b, a barometric sensor 23c, a magnetic sensor 23d, an ultrasonic sensor 23e, and so on.

The three-axis gyro sensor 23a detects a forward-backward inclination, a right-left inclination, and an angular rate of rotation, thus grasping the attitude and motion of the multicopter body. The three-axis acceleration sensor 23b detects acceleration along the front-rear direction, the right-left direction, and the up-down direction. Note that the three-axis gyro sensor and the three-axis acceleration sensor may be implemented by a single module. Such a module may be referred to as a “six-axis gyro sensor”. The barometric sensor 23c grasps the altitude of the multicopter body based on differences in barometric pressure. The magnetic sensor 23d detects azimuth. The ultrasonic sensor 23e emits an ultrasonic wave immediately below and detects a reflection signal to grasp the distance from the ground. Note that the ultrasonic sensor 23e is to be used at a predetermined altitude not far from the ground.

From the radar system 10, the microcontroller 20 acquires information of the detected distance to the target and the detected relative velocity between the unmanned multicopter 1 and the target.

Furthermore, the microcontroller 20 acquires information of the current position of the unmanned multicopter 1 from the GPS module 12. The GPS module 12 receives radio waves from a plurality of artificial satellites (GPS satellites) and computes a distance between itself and each GPS satellite, so as to output information indicating the current position. By utilizing at least four artificial satellites, the GPS module 12 is able to output information identifying the latitude, longitude, and altitude of the unmanned multicopter 1 anywhere around the globe.

The microcontroller 20 acquires a manipulation signal from the reception module 13. The manipulation signal is sent wirelessly from a transmitter on the ground, which is manipulated by the operator. The manipulation signal may be a signal instructing the unmanned multicopter 1 to move forward or make a landing, for example.

Based on signals which are acquired from the sensor group, or on an externally acquired signal, the microcontroller 20 outputs appropriate control signals to the ECUs 14. Upon receiving the control signal, each ECU 14 drives the motor 4. Specifically, each ECU 14 alters the control signal which it outputs to control the rotational speed of the motor 4, or rotate the motor 4.

### 2.2. Radar System

In the present specification, it is assumed that the radar system 10 utilizes radio waves of the millimeter wave band. More specifically, it is preferable to utilize radio waves of the 76 gigahertz (GHz) band or the 79 GHz band.

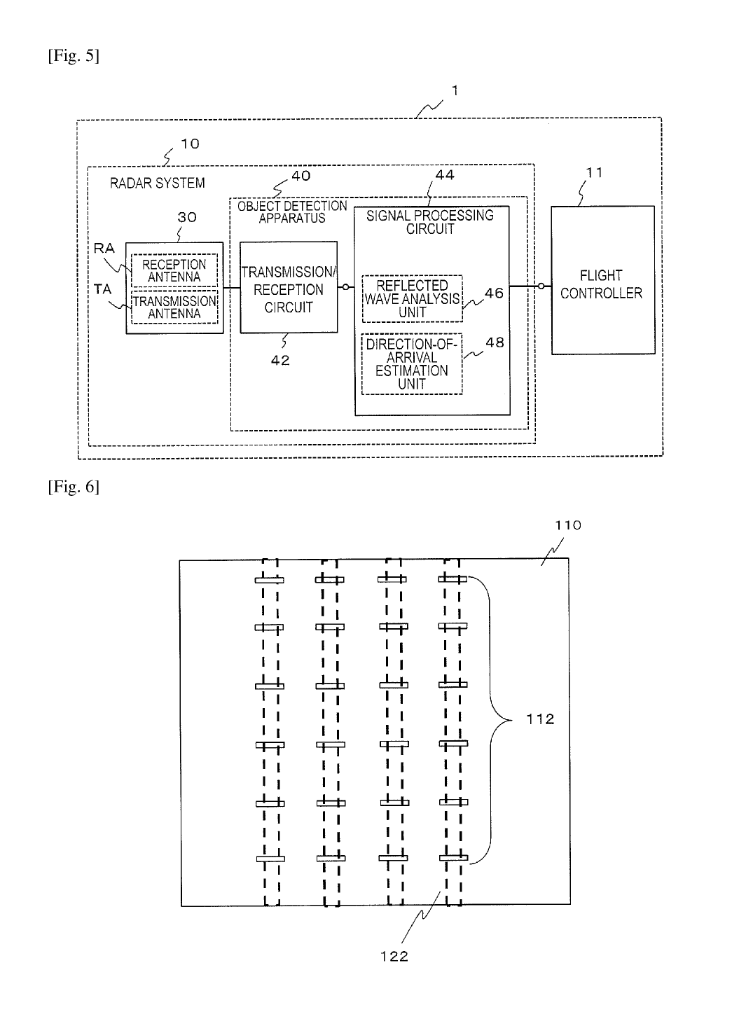

FIG. 5 is a block diagram showing an exemplary fundamental construction, mainly with respect to the radar system 10, of the unmanned multicopter 1 according to the present disclosure.

The radar system 10 shown in FIG. 5 includes a radar antenna 30, which includes the transmission antenna TA and the reception antenna RA, and an object detection apparatus 40. The transmission antenna TA includes at least one antenna element that radiates a signal wave, which may be a millimeter wave, for example. The reception antenna RA includes at least one antenna element that receives a signal wave, which may be a millimeter wave, for example.

The object detection apparatus 40 includes a transmission/reception circuit 42, which is connected to the radar antenna 30, and a signal processing circuit 44.

The transmission/reception circuit 42 generates a signal wave (transmission signal) to be radiated, and sends this transmission signal to the transmission antenna TA. Moreover, the transmission/reception circuit 42 is configured to perform “preprocessing” for a signal wave (reception signal) that is received at the reception antenna RA. A part or a whole of the preprocessing may be performed by the signal processing circuit 44. Typical examples of the preprocessing to be performed by the transmission/reception circuit 20 may include generating a beat signal from a transmission signal and a reception signal, and converting a beat signal in analog format to that in digital format.

Generally speaking, the signal processing circuit 44 performs two processes. One is a process of, with a view to extracting a target-originated reflected wave(s), reducing or eliminating influences of reflected waves originating from the rotors 5, or transmitting and receiving signal waves at moments when the influences of reflected waves originating from the rotors 5 are small. This process is performed by the reflected wave analysis unit 46 in the signal processing circuit 44. Another is a process of estimating the direction of arrival of a target-originated reflected wave, and determining the distance to the target and the relative velocity between the unmanned multicopter 1 and the target. This process is performed by the direction-of-arrival estimation unit 48.

In the present specification, the radar system 10 is contemplated to be a device in which the radar antenna 30 and the object detection apparatus 40 are integrated. However, this is an example. The radar antenna 30 and the object detection apparatus 40 may be separate, and the microcontroller 20 of the flight controller 11 may operate as the signal processing circuit 44 of the object detection apparatus 40.

Hereinafter, the construction of the radar system 10 will be described in detail.

### 2.2.1. Antenna

Any type of antenna element can be used in the unmanned multicopter 1 according to the present disclosure. In the present disclosure, a slot array antenna having ridge waveguides will be illustrated as an example. Although a feed section may also be constructed by utilizing a ridge waveguide, the feed section will be omitted from illustration and explanation. In the following, for simplicity of description, the transmission antenna TA and the reception antenna RA may be denoted as the “antenna TA/RA” or the “slot array antenna TA/RA”. Moreover, the “reception antenna RA” may also be referred to as the “reception antenna array RA”.

FIG. 6 is an upper plan view of a slot array antenna TA/RA in which 24 slots 112 are arrayed in 6 rows and 4 columns. For example, the slot array antenna shown in FIG. 6 may serve respectively as the transmission antenna TA and as the reception antenna RA.

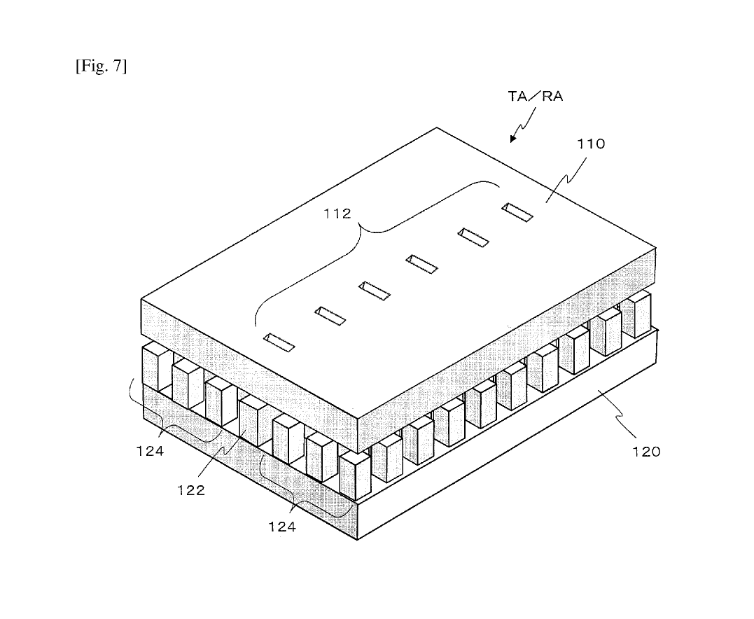

Located below the slots 112 are waveguide members (ridge waveguides) 122, which are indicated by broken lines. Each ridge waveguide 122 corresponds to one antenna element. That is, the antenna shown in FIG. 7 may be regarded as constituting one-dimensional array in which four antenna elements are in parallel arrangement. Each antenna element has an elongated shape with six slot antennas.

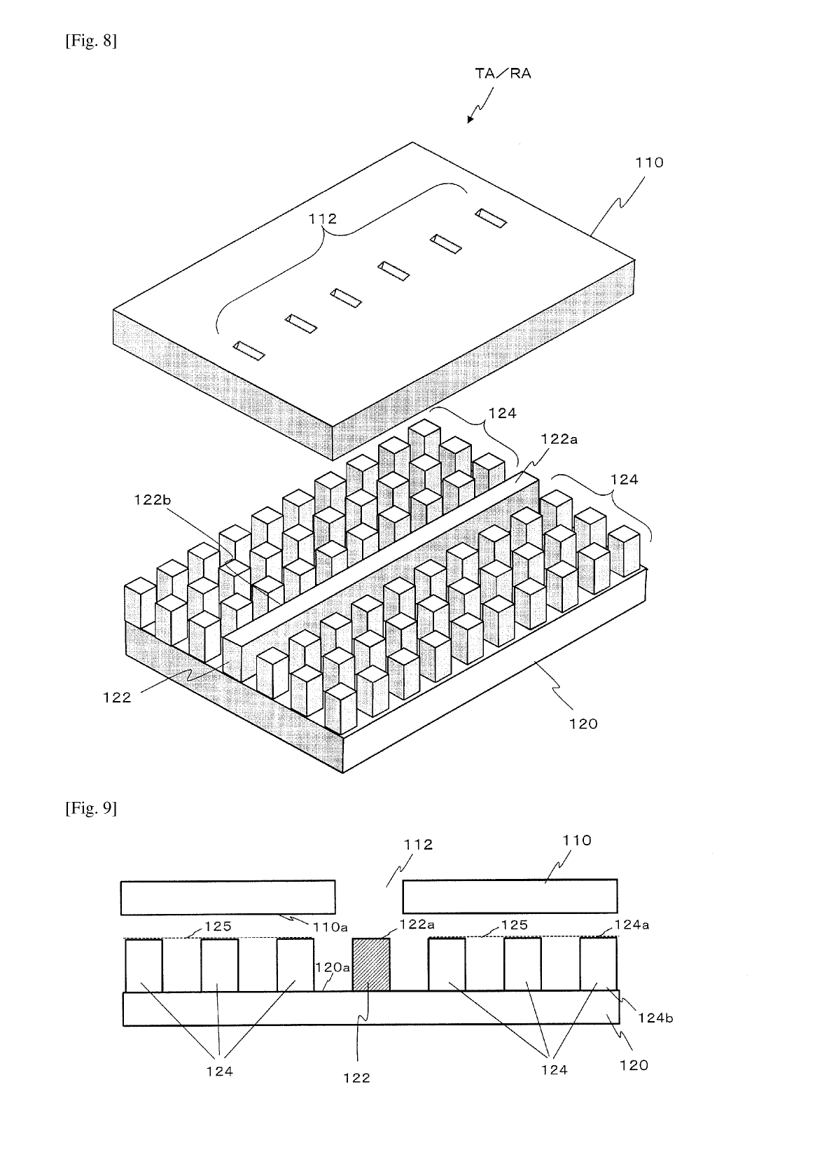

FIG. 7 is a partially-enlarged perspective view along one ridge waveguide 122 in FIG. 6. The illustrated slot array antenna TA/RA includes a first electrically conductive member 110 and an opposing second electrically conductive member 120. FIG. 8 is a perspective view schematically showing the slot array antenna TA/RA, illustrated so that the spacing between the first electrically conductive member 110 and the second electrically conductive member 120 is exaggerated for ease of understanding.

The surface of the first conductive member 110 is composed of an electrically conductive material. The first conductive member 110 includes a plurality of slots 112 as radiating elements. On the second conductive member 120, a ridge waveguide 122 having an electrically-conductive waveguide face 122a opposing a slot row consisting of a plurality of slots 112, and a plurality of conductive rods 124 are provided. The plurality of conductive rods 124 are disposed on both sides of the ridge waveguide 122, constituting an artificial magnetic conductor together with the conductive surface of the first conductive member 110. Signal waves, which are electromagnetic waves, are unable to propagate in the artificial magnetic conductor. Therefore, while propagating in a waveguide which is created between the waveguide face 122a and the conductive surface of the first conductive member 110, a signal wave excites each slot 112. As a result of this, a signal wave is radiated from each slot 112. When the construction of FIG. 6 is utilized as the reception antenna RA, a signal wave is received as it impinges on the plurality of slots 112 and propagates in the reverse path.

FIG. 9 is a cross-sectional view showing the slot array antenna TA/RA through a plane having a normal which is parallel to the direction that a ridge waveguide 122 extends. This figure shows a cross section through the center of a slot 112.

As shown in FIG. 9, the first conductive member 110 has a conductive surface 110a on the side facing the second conductive member 120. The conductive surface 110a has a two-dimensional expanse along a plane which is orthogonal to the axial direction of the conductive rods 124, a plane which is parallel to the XY plane). Although the conductive surface 110a is shown to be a smooth plane in this example, the conductive surface 110a does not need to be a smooth plane, but may be curved or include minute rises and falls.

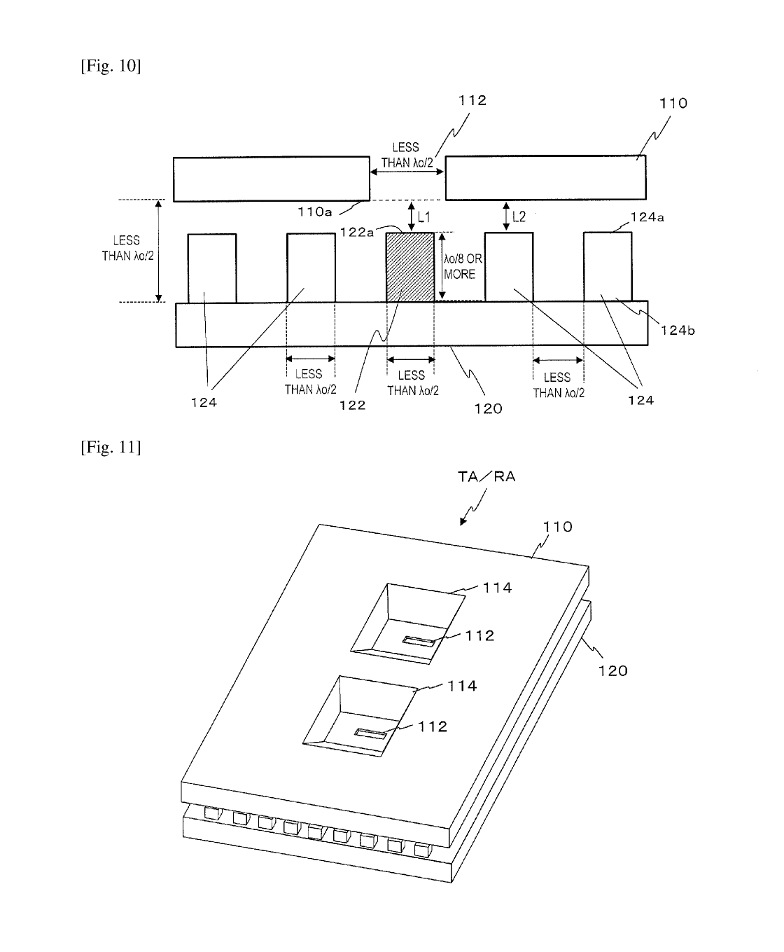

FIG. 10 is a diagram showing example dimensions and relative positioning of components of the slot array antenna TA/RA. The illustrated dimensions are only exemplary.

As indicated in FIG. 10, “Ao” denotes a wavelength (or, in the case where the operating frequency band has some expanse, a central wavelength corresponding to the center frequency) in free space of a signal wave propagating in a waveguide extending between the electrically conductive surface 110a of the first conductive member 110 and the waveguide face 122a of the ridge waveguide 122.

The distance L1 between the waveguide face 122a of the ridge waveguide 122 and the conductive surface 110a is set to less than λo/2. If the distance is λo/2 or more, resonance will occur between the waveguide face 122a and the conductive surface 110a, which will prevent functionality as a waveguide. In one example, the distance is λo/4 or less. In order to ensure manufacturing ease, when a signal wave in the millimeter wave band is to propagate, the distance L1 is preferably λo/16 or more, for example.

The distance L2 from the leading end 124a of each conductive rod 124 to the conductive surface 110a is set to less than λo/2. When the distance is λo/2 or more, a propagation mode that reciprocates between the leading end 124a of each conductive rod 124 and the conductive surface 110a may occur, thus no longer being able to contain a signal wave.

The aforementioned slot array antenna TA/RA is an example. As the transmission antenna TA and/or reception antenna array RA, for instance, a horn antenna, a patch antenna, a slot antenna, or the like may be adopted.

FIG. 11 is a perspective view showing an example of a horn antenna TA/RA. By providing desired horns 114, the directivity of the radiated signal wave can be controlled. Although FIG. 11 illustrates there being two slots 112 and two horns 114, this is for mere convenience of illustration. Other than the horns 114, this construction is similar to that of FIG. 7 or the like.

The radiating elements and a feed section of a horn antenna or a slot antenna can be produced by plating a resin molding with an electrical conductor, for example. As a result, the radiating elements and the like can be reduced in weight.

Although there are 24 slots in the above example, this is only exemplary. As another example, only one slot may be provided for each of the four ridge waveguides 122 in FIG. 6, such that these slots constitute a row along an orthogonal direction to the four ridge waveguides 122.

For teaching of an antenna element including ridge waveguides, the disclosure of Japanese Patent Application No. 2015-217657 is incorporated herein by reference.

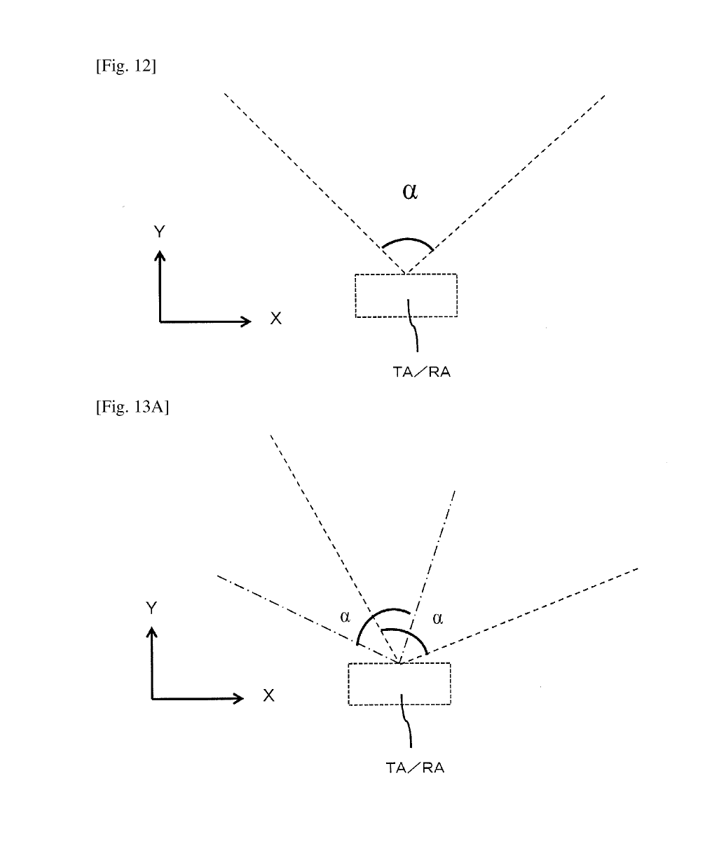

FIG. 12 shows a radiation range of signal waves from the transmission antenna TA. A radiation angle α on the XY plane is shown in the figure. The radiation angle α may be 90 degrees, or 60 degrees, for example. Although the example shown in FIG. 7 is meant to illustrate a plurality of ridge waveguides 112, a slot array antenna including one ridge waveguide may be adopted for the transmission antenna TA in the example of FIG. 12. In this case, intervals among the plurality of slots 112 and the like may be designed so as to adjust the gain and directivity of the antenna TA. FIG. 12 also represents a reception range of signal waves of the reception antenna RA.

FIG. 13A is a diagram showing a radiation range of signal waves from a transmission antenna TA which includes two kinds of transmission antenna elements with different directivities. Such a radiation range can be designed by, for example, adopting a horn antenna structure for two ridge waveguides such that horns are provided on the slot arrays thereof, and by adjusting the position and directivity of each horn. In the construction of FIG. 13A, both of the two kinds of transmission antenna elements have a substantially similar radiation angle α on the XY plane. However, their radiating directions are shifted from each other, with a partial overlap. As a result of this, a transmission antenna TA with a wide directivity can be obtained. In the example of FIG. 13A, too, the radiation angle α may be 90 degrees or 60 degrees, for example.

FIG. 13B shows a radiation range of signal waves, on the YZ plane, from the two kinds of transmission antenna elements shown in FIG. 13A. One of the two kinds of transmission antenna elements radiates radio waves in a range covering up to an angle β above horizontal, while the other radiates radio waves in a range covering up to the angle β below horizontal. The angle β may be 20 degrees, for example. Thus, since signal waves can be radiated over an angle 2·β across the YZ plane, an obstacle can be detected even when the unmanned multicopter 1 flies with an inclined attitude.

Although FIG. 13B employs two symbols to denote the two kinds of transmission antenna elements, this is for mere convenience of illustration. When the slot array antenna shown in FIG. 6 is adopted, each of the two kinds of transmission antenna elements may be composed of the plurality of slots that are provided for one ridge waveguide. They may be designed so that the plurality of slots opposing one of the ridge waveguides have a directivity defined by the radiation angle β (around the Y axis) in the +Z axis direction, while the plurality of slots opposing the other ridge waveguide have a directivity defined by the radiation angle β (around the Y axis) in the −Z axis direction.

Note that it is not essential to employ two kinds of transmission antenna elements as shown in FIG. 13B. One antenna element that is capable of radiating signal waves over the angle β, this angle covering above horizontal and below horizontal alike, may be employed.

In the example of FIG. 1, four sets of transmission antennas TA and reception antennas RA may be provided on the side faces of the central housing 2, where each set consists of one transmission antenna TA and one reception antenna RA. As shown in FIG. 6, each reception antenna RA includes four independent ridge waveguides that are in parallel arrangement, having six slots for each ridge waveguide, totaling 24. Thus, the reception antenna RA is able to function as an array antenna composed of four antenna elements. Each reception antenna element has sensitivity for incident radio waves from a range of 90 degrees on the horizontal plane. Alternatively, each reception antenna element may have sensitivity for incident radio waves from a range of 20 degrees below to 20 degrees above horizontal.

### 2.2.2. Object Detection Apparatus

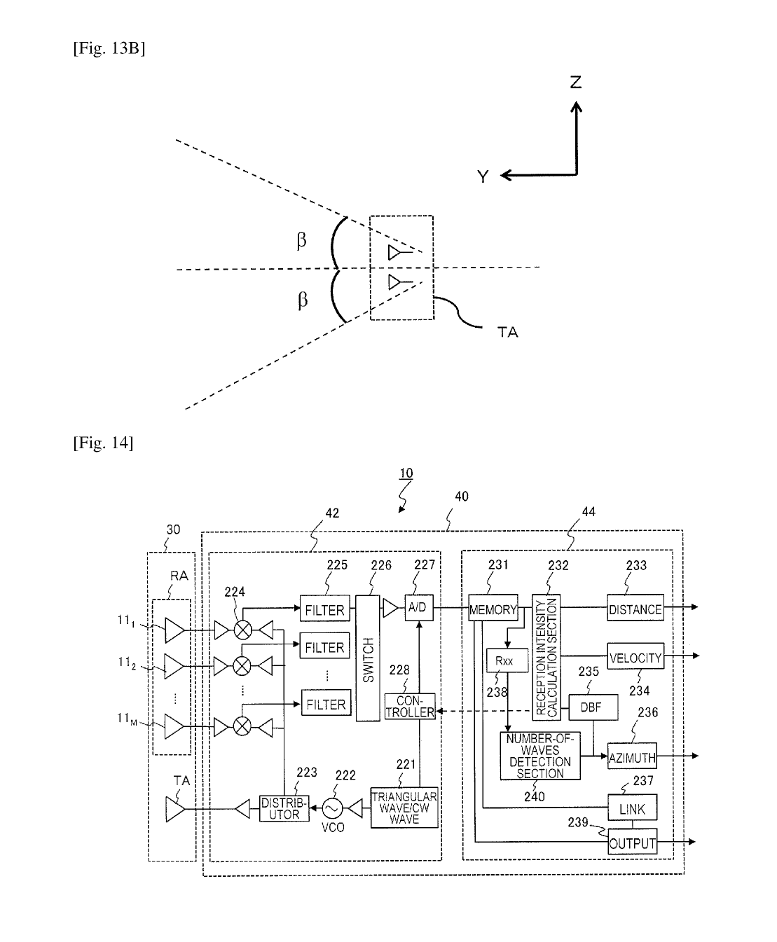

FIG. 14 shows mainly a detailed construction of the object detection apparatus 40. Hereinafter, the transmission/reception circuit 42 and the signal processing circuit 44 of the object detection apparatus 40 will be described in detail. As the reception antenna RA, M kinds of antenna elements 11₁, 11₂, . . . , 11_{M} are shown. Each antenna element is composed of a different ridge waveguide 112 and one or more opposing slots 112.

The transmission/reception circuit 42 includes a triangular wave/CW wave generation circuit 21, a VCO (voltage controlled oscillator) 22, a distributor 23, mixers 24, filters 25, a switch 26, an A/D converter 27, and a controller 28. Although the radar system in the present embodiment is configured to perform transmission and reception of millimeter waves by the CW wave or FMCW method, this is only an example, and other methods can also be adopted. The transmission/reception circuit 42 is configured to generate a beat signal based on a reception signal from the reception antenna RA and a transmission signal from the transmission antenna TA, and output a digital signal thereof.

The signal processing circuit 44 is configured to receive and process a signal which is output from the transmission/reception circuit 42, perform a process of analyzing a reflected wave(s) originating from a rotor(s) 5, and thereafter output signals respectively indicating the detected distance to the target, the relative velocity of the target, and the azimuth of the target.

First, the construction and operation of the transmission/reception circuit 42 will be described in detail.

The triangular wave/CW wave generation circuit 221 generates a triangular wave signal or a CW signal, and supplies it to the VCO 222. The VCO 222 outputs a transmission signal having a frequency as modulated based on the triangular wave signal. Alternatively, the VCO 222 outputs a transmission signal having a constant frequency based on the CW signal. Note that a CW signal is a signal having a constant frequency.

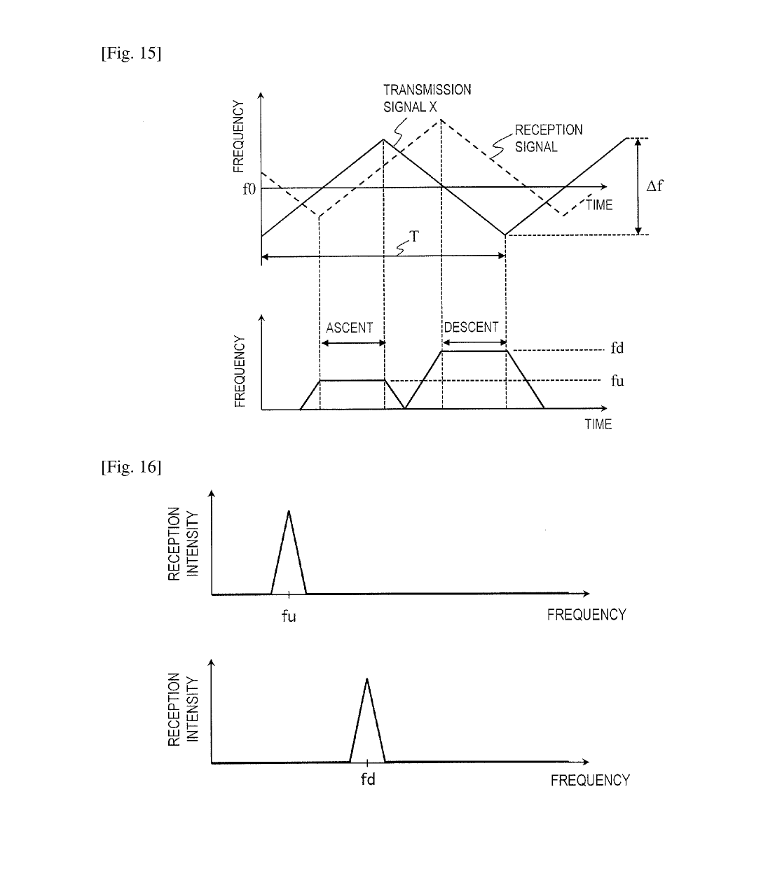

FIG. 15 is a diagram showing change in frequency of a triangular wave signal which is modulated based on the signal that is generated by the triangular wave/CW wave generation circuit 221. This waveform has a modulation width Δf and a center frequency of f0. The transmission signal having a thus modulated frequency is supplied to the distributor 223. The distributor 223 allows the transmission signal obtained from the VCO 222 to be distributed among the mixers 224 and the transmission antenna TA. Thus, the transmission antenna TA radiates a millimeter wave having a frequency which is modulated in triangular waves, as shown in FIG. 15.

In addition to the transmission signal, FIG. 15 also shows an example of a reception signal from an arriving wave which is reflected from a single target. The reception signal is delayed from the transmission signal. This delay is in proportion to the distance between the unmanned multicopter 1 and the target. Moreover, the frequency of the reception signal increases or decreases in accordance with the relative velocity between the unmanned multicopter 1 and the target, due to the Doppler effect.

When the reception signal and the transmission signal are mixed, a beat signal is generated based on their frequency difference. The frequency of this beat signal (beat frequency) differs between a period in which the transmission signal increases in frequency (ascent) and a period in which the transmission signal decreases in frequency (descent). Once a beat frequency for each period is determined, based on such beat frequencies, the distance to the target and the relative velocity of the target are calculated.

FIG. 16 shows examples of a beat frequency fu in an “ascent” period and a beat frequency fd in a “descent” period. In the graph of FIG. 16, the horizontal axis represents frequency, and the vertical axis represents signal intensity. This graph is obtained by subjecting the beat signal to time-frequency conversion. Once the beat frequencies fu and fd are obtained, based on a known equation, the distance to the target and the relative velocity of the target are calculated. In the present embodiment, beat frequencies are determined by utilizing a signal wave which is transmitted from the transmission antenna TA and signal waves which are received by the reception antenna elements RA, thus enabling estimation of the position information of a target.

In the example shown in FIG. 14, reception signals from the reception antennas RA are each amplified by an amplifier, and input to the corresponding mixers 224. Each mixer 224 mixes the transmission signal into the amplified reception signal. Through this mixing, a beat signal is generated corresponding to the frequency difference between the reception signal and the transmission signal. The generated beat signal is fed to a filter 225. The filters 225 apply bandwidth control to the beat signals, and supply bandwidth-controlled beat signals to the A/D converter 227. The A/D converter 227 converts an analog beat signal, which is input in synchronization with a sampling signal, into a digital signal in synchronization with the sampling signal.

The controller 228 may be composed of a microcomputer, for example. Based on a computer program which is stored in a memory such as a ROM, the controller 228 controls the entire transmission/reception circuit 42. The controller 228 does not need to be provided inside the transmission/reception circuit 42, but may be provided inside the signal processing circuit 44. In other words, the transmission/reception circuit 42 may operate in accordance with a control signal from the signal processing circuit 44. Alternatively, some or all of the functions of the controller 228 may be realized by a central processing unit which controls the entire transmission/reception circuit 42 and signal processing circuit 44.

Hereinafter, the construction and operation of the transmission/reception circuit 42 will be described in detail. In the present disclosure, the distance to the target and the relative velocity of the target are estimated by the FMCW method. Without being limited to the FMCW method as described below, the radar system according to the present disclosure can also be implemented by using other methods, e.g., 2 frequency CW and spread spectrum methods.

In the example shown in FIG. 14, the signal processing circuit 44 includes a memory 231, a reception intensity calculation section 232, a distance detection section 233, a velocity detection section 234, a DBF (digital beam forming) processing section 235, an azimuth detection section 236, and a target link processing section 237.

For each of the channels Ch₁ to Ch_{M}, the memory 231 in the signal processing circuit 44 stores a digital signal which is output from the A/D converter 227. The memory 231 may be composed of a generic storage medium such as a semiconductor memory or a hard disk and/or an optical disk.

The reception intensity calculation section 232 applies Fourier transform to the respective beat signals for the channels Ch₁ to Ch_{M} (shown in the lower graph of FIG. 15) that are stored in the memory 231. In the present specification, the amplitude of a piece of complex number data after the Fourier transform is referred to as “signal intensity”. The reception intensity calculation section 232 converts the complex number data of a reception signal from one of the plurality of antenna elements into a frequency spectrum. In the resultant spectrum, beat frequencies corresponding to respective peak values, which are indicative of presence and distance of targets, can be detected.

In the case where there is one target, as shown in FIG. 16, the Fourier transform will produce a spectrum having one peak value in a period of increasing frequency (the “ascent” period) and one peak value in a period of decreasing frequency (“the descent” period). The beat frequency of the peak value in the “ascent” period is denoted “fu”, whereas the beat frequency of the peak value in the “descent” period is denoted “fd”.

From the signal intensities of beat frequencies, the reception intensity calculation circuit or calculator 232 detects any signal intensity that exceeds a predefined value (threshold value), thus determining the presence of a target. Upon detecting a signal intensity peak, the reception intensity calculation section 232 outputs the beat frequencies (fu, fd) of the peak values to the distance detection circuit or detector 233 and the velocity detection circuit or detector 234 as the frequencies of the object of interest. The reception intensity calculation section 232 outputs information indicating the frequency modulation width Δf to the distance detection section 233, and outputs information indicating the center frequency f0 to the velocity detection section 234.

In the case where signal intensity peaks corresponding to plural targets are detected, the reception intensity calculation section 232 find associations between the ascent peak values and the descent peak values based on predefined conditions. Peaks which are determined as belonging to signals from the same target are given the same number, and thus are fed to the distance detection section 233 and the velocity detection section 234.

When there are plural targets, after the Fourier transform, as many peaks as there are targets will appear in the ascent portions and the descent portions of the beat signal. In proportion to the distance between the radar and a target, the reception signal will become more delayed and the reception signal in FIG. 15 will shift more toward the right. Therefore, a beat signal will have a greater frequency as the distant between the target and the radar increases.

Based on the beat frequencies fu and fd which are input from the reception intensity calculation section 232, the distance detection section 233 calculates a distance R through the equation below, and supplies it to the target link processing section 237.

R={C·T/(2*Δf)}·{(fu+fd)/2}

Moreover, based on the beat frequencies fu and fd being input from the reception intensity calculation section 232, the velocity detection section 234 calculates a relative velocity V through the equation below, and supplies it to the target link processing section 237.

V={C/(2·f0)}·{(fu−fd)/2}

In the equation which calculates the distance R and the relative velocity V, C is velocity of light, and T is the modulation period.

Note that the lower limit resolution of distance R is expressed as C/(2Δf). Therefore, as Δf increases, the resolution of distance R increases. In the case where the frequency f0 is approximately in the 76 GHz band, when Δf is set on the order of 600 megahertz (MHz), the resolution of distance R will be on the order of 0.7 meters (m), for example. Therefore, if two targets are traveling abreast of each other, it may be difficult with the FMCW method to identify whether there is one target or two targets. In such a case, it is possible to run an algorithm for direction-of-arrival estimation that has an extremely high angular resolution to separate between the azimuths of the two targets and enable detection.

By utilizing phase differences between signals from the antenna elements 11₁, 11₂, . . . , 11_{M}, the DBF processing section 235 allows the incoming complex data corresponding to the respective antenna elements, which has been Fourier transformed with respect to the time axis, to be Fourier transformed with respect to the direction in which the antenna elements are arrayed. Then, the DBF processing section 235 calculates spatial complex number data indicating the spectrum intensity for each angular channel as determined by the angular resolution, and outputs it to the azimuth detection section 236 for the respective beat frequencies.

The matrix generation section (Rxx) 238 generates a spatial covariance matrix by using the respective beat signals for the channels Ch₁ to Ch_{M} (lower graph in FIG. 15) stored in the memory 231. In the spatial covariance matrix of Equation 1, each component is the value of a beat signal which is expressed in terms of real and imaginary parts. The matrix generation section 238 outputs the resultant spatial covariance matrix Rxx to number-of-waves detection section 240.

$$\begin{matrix}{R}_{xx} = {XX}^{H} \\ = [ \begin{matrix}{Rxx}_{11} & … & {Rxx}_{1 M} \\ ⋮ & & ⋮ \\ {Rxx}_{M 1} & … & {Rxx}_{MM}\end{matrix} ]\end{matrix} \qquad [ eq . 1 ]$$

The number-of-waves detection section 240 calculates eigenvalues λ₁ to λ_{K} of the spatial covariance matrix Rxx. Herein, k corresponds to the number of ridge waveguides in the reception antenna RA. The relationship among the eigenvalues λ₁ to λ_{K} is as follows.

λ₁≥λ₂≥λ₃≥ . . . ≥λ_{L}>λ_{L+1}≥λ_{K}=σ² [eq. 2]

In the above, σ² corresponds to thermal noise. Thus, the number of arriving waves L can be estimated from the number of eigenvalues which are greater than the thermal noise power σ².

The azimuth detection section 236 is provided for the purpose of estimating the azimuth of a target. Among the values of spatial complex number data that has been calculated for the respective beat frequencies, the azimuth detection section 236 chooses an angle θ that takes the largest value, and outputs it to the target link processing section 237 as the azimuth at which an object of interest exists. Note that the method of estimating the angle θ indicating the direction of arrival of an arriving wave is not limited to this example. Various algorithms for direction-of-arrival estimation that have been mentioned earlier can be employed. For example, with a maximum likelihood estimation technique such as the SAGE (Space-Alternating Generalized Expectation-maximization) method, azimuths of plural arriving waves with high correlation can be detected by utilizing information on the number of arriving waves. Since maximum likelihood estimation techniques such as SAGE are known techniques, detailed descriptions thereof are omitted. The azimuth of arrival of a radio wave may be estimated by using an amplitude monopulse method.

As the process of azimuth detection, both of the following routes exist in the signal processing circuit 44: a route from the reception intensity calculation section 232, through the DBF processing section 235, to the azimuth detection section 236; and a route from the correlation matrix generation section 238, through the number-of-waves detection section 240, to the azimuth detection section 236. Depending on the situation, the signal processing circuit 44 may switch between these routes (i.e., methods of azimuth of arrival estimation). Note that processes by both routes may be allowed to operate in parallel, and if they have matching results, the matching result may be output as an estimation azimuth result for the target, thus enhancing the accuracy of direction estimation. Alternatively, a plurality of data which are consecutively acquired by transmitting/receiving signal waves e.g. every 10 milliseconds may be alternately fed to the two routes for estimation processes, and if their estimation results match by a rate which is equal to or greater than a predetermined value, the substantially-matching result may be output as an estimation azimuth result for the target, thus enhancing the accuracy of direction estimation. It is not essential to provide two such routes; only one of them may be provided.

The target link processing section 237 calculates absolute values of the differences between the respective values of distance, relative velocity, and azimuth of the object of interest as calculated in the current cycle and the respective values of distance, relative velocity, and azimuth of the object of interest as calculated 1 cycle before, which are read from the memory 231. Then, if the absolute value of each difference is smaller than a value which is defined for the respective value, it is determined that the target that was detected 1 cycle before and the target detected in the current cycle are an identical target. In that case, the target link processing section 237 increments the count of target link processes, which is read from the memory 231, by one.

If the absolute value of a difference is greater than predetermined, the target link processing section 237 determines that a new object of interest has been detected. The target link processing section 237 stores the respective values of distance, relative velocity, and azimuth of the object of interest as calculated in the current cycle and also the count of target link processes for that object of interest to the memory 231, via a target output processing section 239.

When the object of interest is a structure ahead, the target output processing section 239 outputs the identification number of that object of interest as indicating a target. When receiving results of determination concerning plural objects of interest, such that all of them are structures, the target output processing section 239 outputs object position information indicating where a target is. If information indicating that there is no prospective target is input from the reception intensity calculation section 232, the target output processing section 239 outputs zero, indicating that there is no target, as the object position information.

Through operations of the above-described constituent elements, the signal processing circuit 44 detects an azimuth at which an object of interest exists, a distance from the object of interest, and a relative velocity.

A whole or a part of the signal processing circuit 44 may be implemented by FPGA, or a set of a general-purpose processor(s) and a main memory device(s). The memory 231, the reception intensity calculation section 232, the DBF processing section 235, the distance detection section 233, the velocity detection section 234, the azimuth detection section 236, and the target link processing section 237 may be functional blocks of a single signal processing circuit, rather than individual parts that are implemented in distinct pieces of hardware.

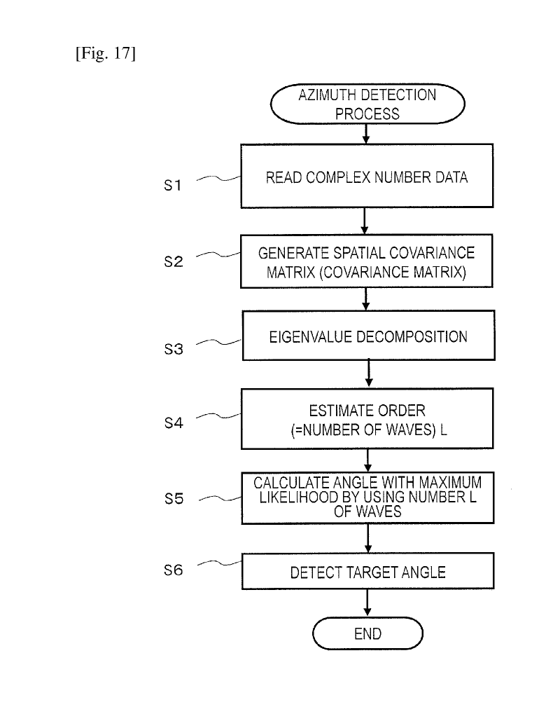

FIG. 17 is a flowchart showing a procedure of processing by the object detection apparatus 40. More specifically, FIG. 17 corresponds to the processing by the direction-of-arrival estimation unit 48 in the signal processing circuit 44 (FIG. 5).

The direction-of-arrival estimation unit 48 generates a steering vector based on reception waves originating from a target, performs likelihood calculation as to directions of arrival of reflected waves, and calculates a direction of arrival (angle) for which the likelihood is the largest (highest) to be the direction in which the target exists. Specifically, this works as follows.

At step S1, from the memory 231, the correlation matrix generation section 238 reads the data (complex number data) of the respective beat signals for the channels Ch₁ to Ch_{M} as stored in the memory 231. Next, at step S2, in accordance with eq. 1, the correlation matrix generation section 238 generates a spatial covariance matrix from the complex number data.

At step S3, the number-of-waves detection section 240 performs eigenvalue decomposition for the spatial covariance matrix Rxx to calculate eigenvalues λ₁ to λ_{K}, and further at step S4, determines an degree (number of waves) L that satisfies the relationship of eq. 2.

At step S5, by using the number of waves L, the azimuth detection section 236 calculates an angle(s) for which the likelihood is the largest (maximum likelihood). This process determines a number L of solutions θ that define local maximums of a mathematical function whose parameter is angle. Specific details of this mathematical function will be omitted from explanation.

Then, at step S6, the azimuth detection circuit 37 identifies the angle of the target. The above process may be e.g., the MUSIC method, which is a known algorithm for direction-of-arrival estimation. By using such an algorithm, the azimuth detection circuit 37 is able to estimate an azimuth (angle) of a target. When multibeam antenna TA/RA are used, it would be possible to estimate an azimuth of arrival of a radio wave by using an amplitude monopulse method.

### 3. Reflection of Signal Waves by a Rotor

Next, reflection of signal waves from a rotor 5 will be described.

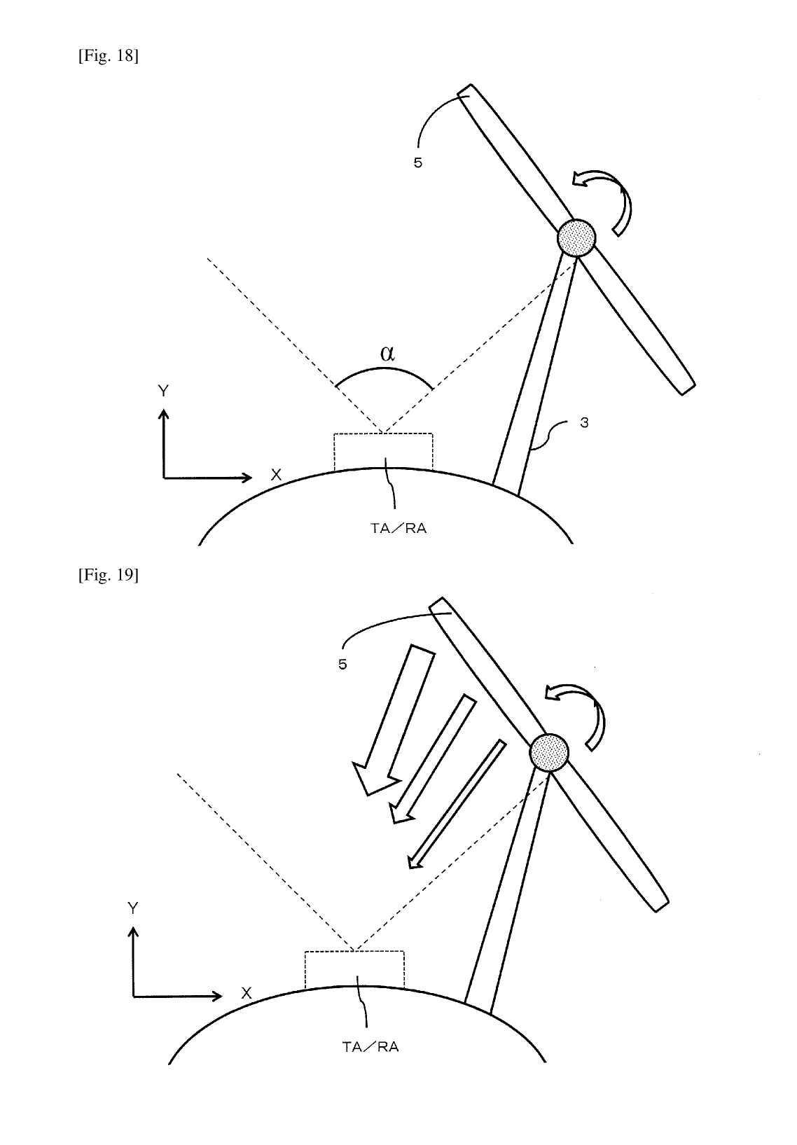

FIG. 18 shows relative positioning between a transmission antenna TA a rotor 5. When a signal wave is radiated from the transmission antenna TA at a radiation angle α while a rotor 5 exists within this angle, the signal wave will be reflected by the rotor 5. Note that, although the radiation angle α is conveniently illustrated as an angle projected on the XY plane, the antenna TA/RA and the rotor 5 are actually placed with a slight offset along the Z axis direction as described above.

FIG. 19 schematically shows reflected waves originating from a rotor 5. To facilitate understanding, the magnitude of difference between the frequency of a transmission wave and the frequency of a reflected wave is indicated by the thickness of each arrow.

When the rotor 5 rotates, the rotational speeds of minuscule points on the rotor 5 differ depending on distance from the axis of rotation. The relative velocity of the rotor 5 with respect to the radar is the largest at the tip of the rotor 5, and gradually decreases towards the center, until reaching zero at the center of the rotor. It may be said that peripheral velocity of the rotor 5 has a very wide range of distribution depending on the position of the radius of gyration.

Between the transmission antenna TA and each minuscule point on the rotor 5 during rotation, there exists a non-zero relative velocity. Therefore, the frequency difference between a transmission wave and a reception wave reflected off the rotor 5 is under the influence of a Doppler shift in accordance with the reflected position. It is a transmission wave reflected at the tip of the rotor 5 (where the movement is fastest) that is most affected by the Doppler shift.

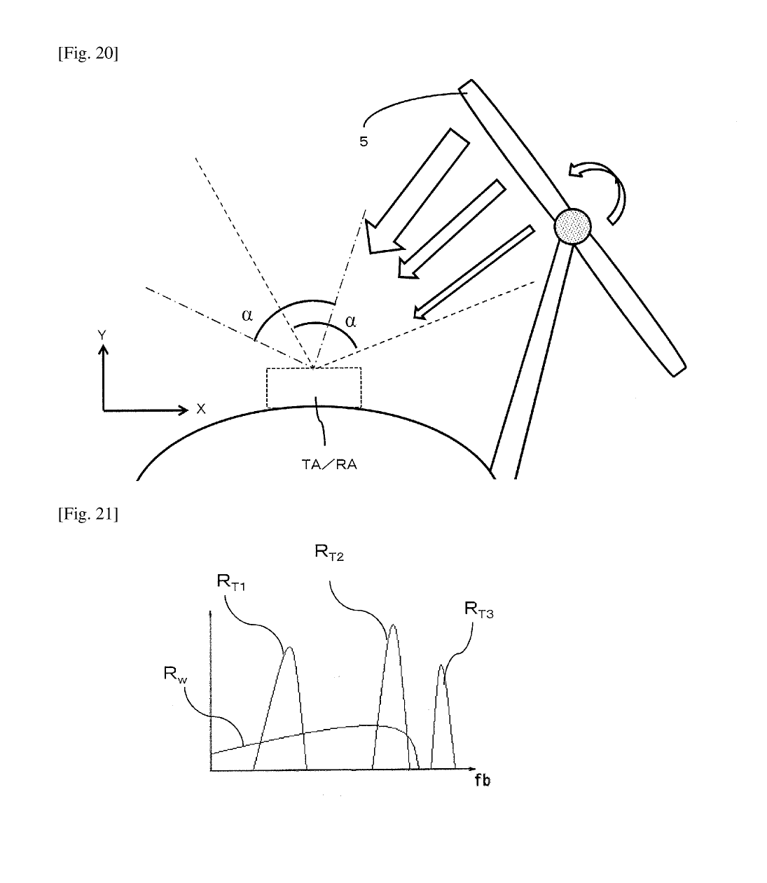

FIG. 20 schematically shows reflected wave originating from a rotor 5 when a transmission antenna TA which includes two kinds of transmission antenna elements with different directivities is used. In the example of FIG. 20, the position of the rotor 5 and the positions of the two kinds of transmission antenna elements are adjusted so that only signal waves from one of the transmission antenna elements will be reflected off the rotor 5 in FIG. 20.

When the radar system 10 adopts the FMCW method in measuring a distance to a target, etc., it performs distance calculation based on a difference between the frequency of an incident wave and the frequency of a reflected wave. When a relative velocity exists between the unmanned multicopter 1 and the target, the frequency difference is under the influence of a Doppler shift. Usually, a frequency difference Δfd based on a Doppler shift is much smaller than a frequency difference Δfr that occurs as a radio wave reciprocates to and from a target. Therefore, Δfd and Δfr can be relatively easily distinguished from each other.

However, in the case of a rotor 5 of the unmanned multicopter 1, the peripheral velocity at the tip of the rotor may be as large as 100 m/s or even higher. Under these circumstances, a phenomenon that the range of Δfd and the range of Δfr overlap may occur.

The inventors have found that, generally speaking, a radar system based on the FMCW method cannot be used under such circumstances. Accordingly, the inventors have studied a process of extracting a target-originated reflected wave while accounting for the influences of rotor-originated reflected waves. Hereinafter, the processing by the radar system which resulted from the study of the inventors will be described.

### 4. Processing by the Radar System

### Embodiment 1

In the present embodiment, the radar system 10 performs a target detecting process at moments when the influence of a reflected wave originating from a rotor 5 is small.

FIG. 21 is a frequency spectrum chart showing a relationship between beat signals respectively corresponding to a reflected wave from the rotor 5 and reflected waves from targets, in a radar system 10 which operates by the FMCW method. In actuality, the frequency spectrum to be obtained will be a total of all waveforms in FIG. 21.

A reflected wave Rw from the rotor 5 (a “reflected wave originating from a rotor(s) 5”) has a very broad frequency spectrum because, as has been described with reference to FIG. 19 and FIG. 20, the peripheral velocity of the rotor 5 significantly varies with distance from the axis of rotation. In other words, the relative velocity between the antenna TA/RA and each minuscule point on the rotor 5 will have a very wide distribution. On the other hand, reflected waves (target-originated reflected waves) R_{T1} to R_{T3} from targets will each have a narrow frequency spectrum. Therefore, if one can detect peaks of the target-originated reflected waves R_{T1} to R_{T3} from the synthetic frequency spectrum of the reception waves, it will be possible to discern only the peaks which are associated with the target.

FIG. 22 is a flowchart showing a procedure of processing by the reception intensity calculation section 232 of the signal processing circuit 44 according to the present embodiment.

At step S11, the reception intensity calculation section 232 reads complex number data of a reception signal from the memory 231.

At step S12, the reception intensity calculation section 232 applies fast Fourier transform, for example, to the complex number data, thereby obtaining a frequency spectrum.

At step S13, the reception intensity calculation section 232 determines whether the frequency spectrum contains a frequency band that satisfies the peak condition. More specifically, the reception intensity calculation section 232 determines whether or not the beat signal frequency spectrum contains a frequency band which satisfies the condition of being within a certain frequency span and yet having a predetermined intensity or greater. Specific values of the certain frequency span and the predetermined intensity may be set in accordance with the specifications of the radar system 10. If the aforementioned peak condition is satisfied, the process proceeds to step S14; if not, the process proceeds to step S15.

At step S14, for each frequency band that satisfies the peak condition, the reception intensity calculation section 232 identifies a greatest intensity therein, i.e., a peak-defining frequency. As a result, peak frequencies corresponding to the target-originated reflected waves R_{T1} to R_{T3} (FIG. 21) are determined.

On the other hand, at step S15, the reception intensity calculation section 232 reads the complex number data of a next reception signal, and the process returns to step S12.

Once peak-defining frequencies are identified, the signal processing circuit 44 is able to perform a target detection process, without having to remove any reflected waves off the rotor 5.

In addition to the above process, by utilizing the spectrum of a reception wave when the reflected wave Rw originating from a rotor(s) 5 becomes smallest, a peak corresponding to the target may be detected. The waveform of each reflected wave shown in FIG. 21 is based on a reflected wave that is received at a given moment. At different moments, the reflected wave Rw originating from the rotor 5 may become greater or smaller. The reflected wave Rw being smallest means least noise, i.e., a most clearly defined peak. The reception intensity calculation section 232 may continuously derive a reception wave spectrum, and detect a peak when the reflected wave Rw originating from a rotor(s) 5 becomes smallest.

As shown in FIG. 21, the reception wave at least contains reflected waves R_{T1} to R_{T3} originating from the target and reflected wave Rw originating from the rotor 5. It will be preferable if the reflected wave Rw originating from the rotor 5 can be removed. A high-pass filter such as a differential filter may be used to this end. A differential filter is generally used to extract a high-frequency component. With a first order differential filter, or a differential filter of the second order or above, the reflected wave Rw originating from the rotor 5 shown in FIG. 21 will be removed, thereby making it easier to extract the reflected waves R_{T1} to R_{T3} originating from the target. Depending on the shape and relative positioning of the rotors 5, instead of a simple high-pass filter, a high-pass filter that acts like a second order differential filter or a filter that permits passage in response to the rise of a peak may be used, for example, thereby being able to extract the reflected waves R_{T1} to R_{T3} originating from the target with an increased certainty from among the reflected waves. Higher-order differential filters will be able to respond more sharply to a steep edge to pass the wave.

Use of a differential filter is only an example. In more general terms, a method may be adopted which pays attention to the rate of change of spectrum intensity such that, if the rate of change reaches a predetermined value or greater, any peak within the frequency band in which such change has occurred is regarded as a target-originated peak, whereby target-originated peaks can be detected.

### Embodiment 2

The present embodiment will illustrate a process in which the object detection apparatus 40 transmits a signal wave at a moment when the angle or solid angle as any rotor 5 is viewed from the antenna TA/RA is equal to or smaller than the predetermined value. Based on a signal wave which is received by the reception antenna RA, the object detection apparatus 40 estimates a moment at which the angle or solid angle is equal to or smaller than the predetermined value, and causes a signal wave to be transmitted from the transmission antenna TA based on the estimation result. Even if the transmission antenna TA and the reception antenna RA are composed of separate antenna elements, the present embodiment will regard both as being at substantially the same position.

Note that the reception antenna RA in the present embodiment is composed of a one-dimensional array as shown in FIG. 6, and is able to detect an incident azimuth of a reflected wave. However, in order to detect a moment at which the angle expanse or solid angle as any rotor 5 is viewed from the antenna TA/RA becomes smallest, it is not necessary to detect the incident azimuth of a reflected wave, because a peak of a reflected wave originating from a rotor 5 can be discerned from the shape, etc., of the peak in the reception wave spectrum. Since the height and frequency of the peak will vary in accordance with the magnitude of the angle expanse or solid angle as any rotor 5 is viewed from the antenna TA/RA, this relationship can be relied on in detecting a moment at which the angle expanse or solid angle becomes smallest.

Detection of a moment at which the solid angle becomes equal to or smaller than the predetermined value is performed by radiating a transmission wave from the radar system 10, and receiving a signal wave. The present embodiment will illustrate the CW method and the FMCW method as examples. Hereinafter, a non-modulated continuous wave to be utilized in the CW method will simply be referred to as a “continuous wave CW”, whereas a frequency modulated continuous wave to be utilized in the FMCW method will be referred to as a “frequency modulated continuous wave FMCW”.

In the present embodiment, it is assumed that the position and/or radiation range of the transmission antenna TA is/are adjusted so that only one rotor can fit within the radiation range of each transmission antenna TA.

In the present embodiment, an unmanned multicopter 1 including rotors 5 as follows will be described as an example.

TABLE 1

| | number of | | peripheral | time per |
|---|---|---|---|---|
| rotor | revolutions | rotor | velocity | rotation |
| diameter | (rpm) | radius | (m/sec) | (msec) |
| 30 inches | 1000 | 0.38 | 40 | 60 |
| 30 inches | 2000 | 0.38 | 80 | 30 |
| 30 inches | 3000 | 0.38 | 119 | 20 |

### 1. Example of Using Continuous Wave CW

When the transmission antenna TA radiates a continuous wave CW of a constant frequency, the reception antenna RA will receive a signal wave that contains a reflected wave(s) of that continuous wave CW. Generally speaking, a beat signal which is obtained from a transmission wave and a reception wave has a frequency corresponding to the difference between the frequency of the radiated wave and the frequency of the reflected wave.

A signal wave which is received at the reception antenna RA contains a reflected wave(s) originating from a rotor 5. Therefore, the difference between the frequency of a transmission wave and the frequency of a reception wave reflected off the rotor 5 is under the influence of a Doppler shift in accordance with the reflected position. As a result, the beat signal frequency spectrum in the case of CW radiation spans a very wide range from higher frequencies to lower frequencies.

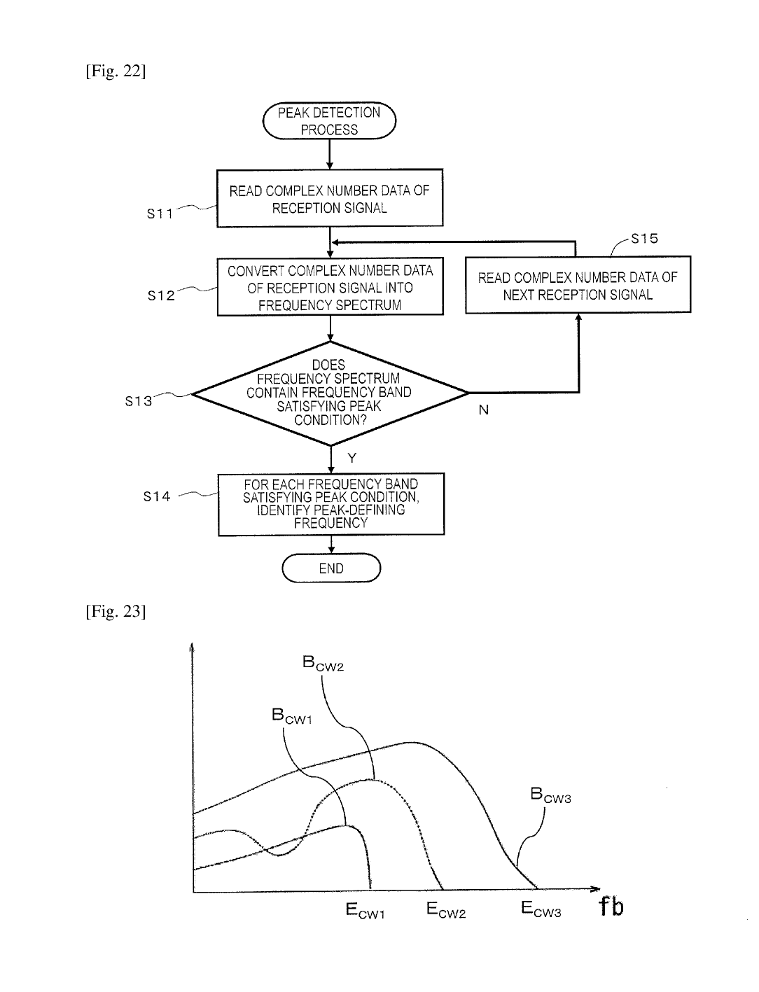

FIG. 23 shows example frequency spectra of three beat signals B_{CW1} to B_{CW3} which are respectively obtained from continuous waves CW and three reflected waves originating from a rotor(s) 5. It can be said that none of these beat signals has a steep peak, but rather each has a relatively broad frequency spectrum. For convenience of explanation, it is assumed that the beat signals B_{CW1} and B_{CW3} are the smallest waveform and the largest waveform, respectively, among the waveforms of the detected beat signals.

Edges E_{CW1} to E_{CW3}, representing the highest frequency of each beat signal, are indicative of the greatest influence of a Doppler shift being exerted within the respective reception wave. That is, the edges E_{CW1} to E_{CW3} each originate from a reflected wave reflected off the tip of a rotor 5, which is the fastest-moving portion of the rotor 5.

Furthermore, the relationship between the edges E_{CW1} to E_{CW3} indicates that the largest edge E_{CW3} corresponds to the rotor 5 appearing sideways (i.e., orthogonal to a line of sight) as viewed from the antenna TA/RA, because the difference in the relative velocity between the tip of the rotor 5 and the antenna TA/RA becomes greatest under such relative positioning. Therefore, as the rotor 5 becomes increasingly oblique with respect to the antenna TA/RA, the edge of the beat signal will shift toward lower frequencies. In other words, the edge will shift from E_{CW3} to E_{CW2} to E_{CW1}.

As the rotor 5 becomes increasingly oblique with respect to the antenna TA/RA, the reflected waves originating from the rotor 5 become weaker. This results in the amplitude being smaller. Since the blade shape will also exert increasing influences, rises and falls are likely to occur in the beat signal waveform. This results in a complicated waveform, as exemplified by e.g. the beat signal E_{CW2}.

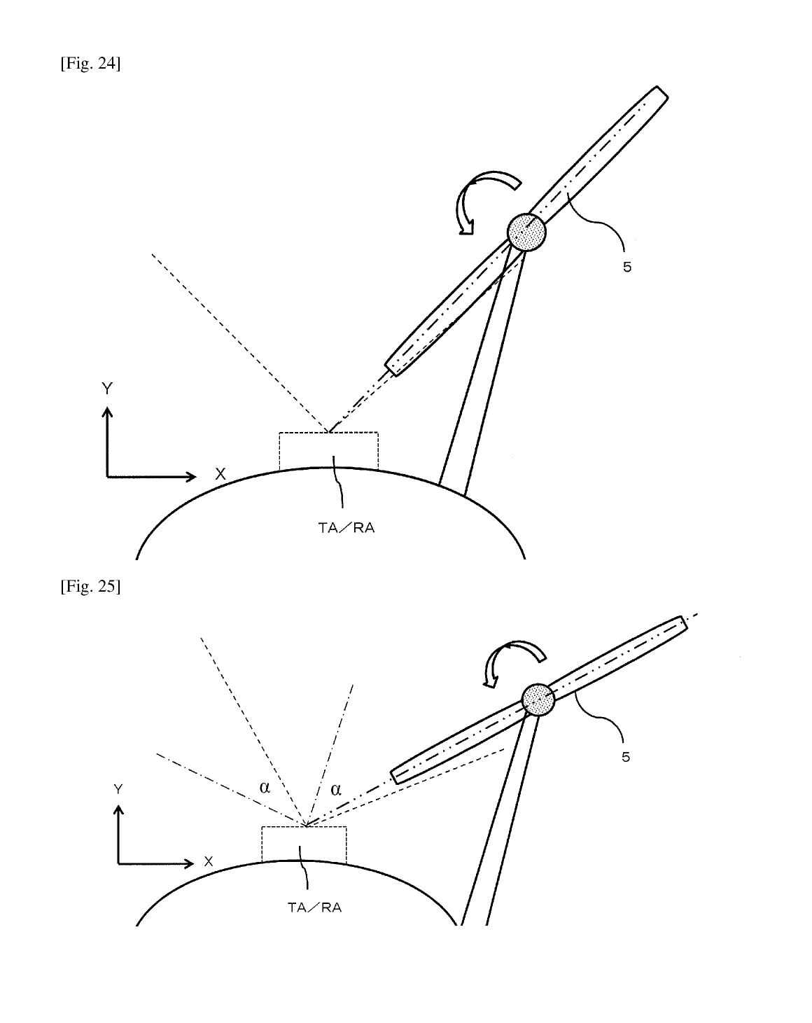

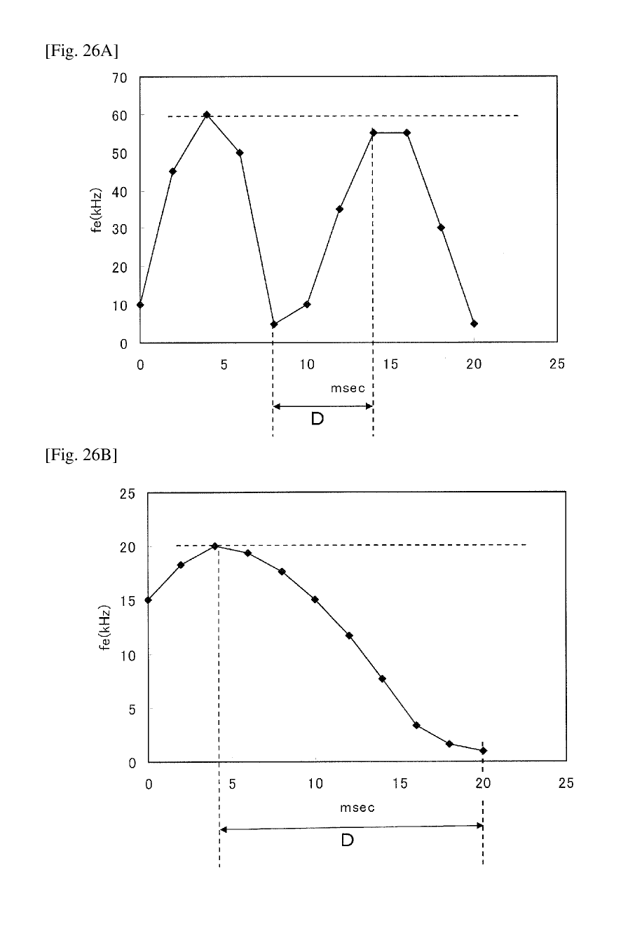

When the rotor 5 appears smallest as viewed from the antenna TA/RA, the detected influence of the reflected waves originating from the rotor 5 in the reception wave at the reception antenna RA is smallest. This is the moment when the solid angle of the rotor 5 becomes smallest relative to the antenna TA/RA. In the present embodiment, the beat signals which have so far been obtained are used in identifying the moment when the solid angle of the rotor 5 becomes smallest, and also identifying a next moment when the solid angle of the rotor 5 will become smallest. FIG. 24 and FIG. 25 schematically show, in the constructions corresponding to FIGS. 19 and 20, respectively, a moment at which the solid angle of a rotor 5 becomes smallest and the position of the rotor 5 at that point.

Hereinafter, this will be described with respect to specific examples.

The triangular wave/CW wave generation circuit 221 (FIG. 14) generates ten continuous waves CW each lasting for 1 millisecond, with intervals of 1 millisecond therebetween, and transmits them via the transmission antenna TA. In other words, it takes 19 milliseconds for the series of continuous waves CW to complete transmission. Note that the 1 millisecond period between a continuous wave CW and a next continuous wave CW is sufficiently longer than the period from when a signal wave is radiated from the transmission antenna TA until it is reflected off the rotor 5 and returns to the reception antenna RA. It can be said that the motion of the incessantly-rotating rotor 5 reflects on the reception wave at the reception antenna RA.

Each continuous wave CW is radiated from the transmission antenna TA as a transmission wave. As a reception wave, the reception antenna RA receives a reflected wave of the continuous wave CW. Each mixer 224 mixes the transmission wave and the reception wave to generate a beat signal. The A/D converter 227 converts the beat signal, which is an analog signal, into a digital signal. The reception intensity calculation section 232 detects an edge E_{CW} of each beat signal, i.e., the highest frequency thereof.

Let the rotor 5 be rotating at 3000 rpm. It is assumed however that information of the number of revolutions is unknown to the signal processing circuit 44.

The radiation period of 19 milliseconds of continuous waves CW allows the rotor 5 to make one revolution. This makes it possible to identify the smallest beat signal B_{CW1} and the largest beat signal B_{CW3} as shown in FIG. 23.

FIG. 26A shows frequency transitions of a beat signal edge E_{CW}. Since two blades are provided for each rotor 5, while the rotor 5 makes one revolution, there are two moments that the two blades appear sideways (i.e., orthogonal to a line of sight) as viewed from the transmission antenna TA: near 4 milliseconds and near 15 milliseconds.

The moment when the frequency between the two peaks becomes lowest (i.e., near 8 milliseconds) represents the rotor 5 appearing smallest as viewed from the transmission antenna TA. This moment is no other than the moment of smallest solid angle as viewed from the antenna TA/RA.

The reception intensity calculation section 232 estimates a next moment when the solid angle will become smallest. For example, based on a time interval D between the moment when the highest frequency of the beat signal becomes smallest and the moment when it becomes largest, the reception intensity calculation section 232 calculates a number of revolutions of the rotor 5. This time interval is the amount of time required to cope with ¼ revolutions. As a result, given the same number of revolutions, the reception intensity calculation section 232 is able to estimate that a next moment when the solid angle will become smallest is at the lapse of the time interval D since the moment when the highest frequency of the beat signal becomes largest.

A different number of revolutions will now be taken as another example.

Let the rotor 5 be rotating at 1000 rpm. It is assumed however that information of the number of revolutions is unknown to the signal processing circuit 44.

The radiation period of 19 milliseconds of continuous waves CW allows the rotor 5 to make ⅓ revolutions. On the other hand, the time interval D between the moment when the highest frequency of the beat signal becomes smallest and the moment when it becomes largest corresponds to ¼ revolutions. Therefore, at least one moment when the highest frequency of the beat signal becomes smallest and at least one moment when the highest frequency of the beat signal becomes largest exist, and the time interval D therebetween can also be identified.

FIG. 26B shows frequency transitions of a beat signal edge E_{CW}. It can be seen that the time interval D is thus identified.

Based on the time interval D between the moment when the highest frequency of the beat signal becomes smallest and the moment when it becomes largest, the reception intensity calculation section 232 calculates a number of revolutions of the rotor 5. This time interval is the amount of time required to cope with ¼ revolutions. As a result, given the same number of revolutions, the reception intensity calculation section 232 is able to estimate that a next moment when the solid angle will become smallest is at the lapse of the time interval D since the moment when the highest frequency of the beat signal becomes largest.

In addition to the method based on the time interval D, other methods of calculating a number of revolutions of the rotor 5 may also be possible. For example, the number of revolutions of the rotor 5 may be directly calculated based on a beat signal. Specifically, first, the highest frequency of a beat signal (e.g., the maximum peak shown in FIG. 26A or FIG. 26B) is detected. At the moment when the highest frequency of the beat signal becomes largest, the direction in which the blade-tip of the rotor 5 travels is basically identical to the azimuth in which the antenna TA/RA exists (i.e., the direction that the rotor 5 heads toward the antenna TA/RA). Therefore, from the beat signal at that time, the relative velocity between the blade-tip of the rotor 5 and the antenna TA/RA, i.e., the peripheral velocity of the rotor 5, can be calculated. Once the peripheral velocity is calculated, a number of revolutions can be calculated by using information of the diameter of the rotor 5. The diameter of the rotor 5 may be fed in advance to a calculation circuit such as the reception intensity calculation section 232, for example.

In each of the above examples, a next moment that the solid angle will become smallest is estimated; however, the solid angle does not always need to be smallest. The solid angle may, for example, fall within a predefined range that contains the minimum value. Furthermore, the moment to be estimated does not need to be the “next”, but may be the “second next”, or the “third next”. In other words, any subsequent moment that the solid angle becomes smallest may be estimated.

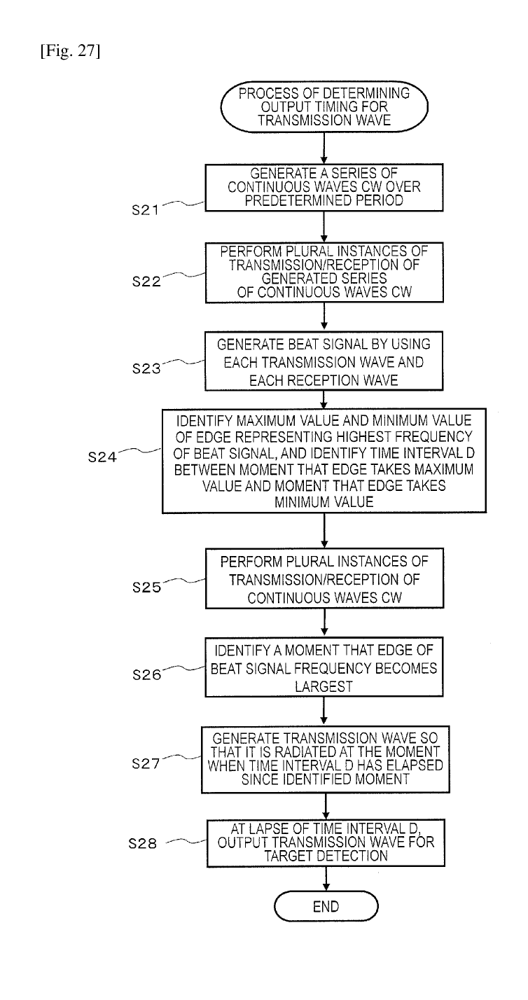

FIG. 27 is a flowchart showing a procedure of a process of determining signal wave transmission timing by using continuous waves CW.

At step S21, the triangular wave/CW wave generation circuit 221 generates a series of continuous waves CW over a predetermined period.

At step S22, the transmission antenna TA and the reception antenna RA perform plural instances of transmission/reception of the generated series of continuous waves CW.

At step S23, the mixer 224 generates a beat signal by using each transmission wave and each reception wave. Note that the process of step S21, the process of step S22, and the process of step 23 are to be performed in parallel fashion by the triangular wave/CW wave generation circuit 221, the antenna TA/RA, and the mixers 224, respectively, rather than step S22 following only after completion of step S21, or step 23 following only after completion of step 22.

At step S24, the reception intensity calculation section 232 identifies a maximum value and a minimum value of the edge representing the highest frequency of the beat signal, and identifies the time interval D between the moment that the edge takes the maximum value and the moment that the edge takes the minimum value.

At step S25, the transmission antenna TA and the reception antenna RA performs plural instances of transmission/reception of continuous waves CW.

At step S26, the reception intensity calculation section 232 identifies a moment that the edge of beat signal frequency becomes largest.

At step S27, the triangular wave/CW wave generation circuit 221 generates a transmission wave so that the transmission wave is radiated at the moment when the time interval D has elapsed since the identified moment.

At step S28, at the lapse of the time interval D, the transmission antenna TA outputs a transmission wave for target detection.

Once the output timing for the transmission wave is determined, thereafter, in the manner described above, a process of transmitting a signal wave, a process of receiving a reflected wave, and a process of distance and relative velocity determination by generating a beat signal based on the transmission wave and the reception wave may be performed.

### 2. Example of Using Frequency Modulated Continuous Wave FMCW

Next, an example of radiating frequency modulated continuous waves FMCW will be described.

Peaks of beat signals which are obtained from a transmission wave and reflected waves originating from a rotor 5 are hardly different from those in the case of continuous waves CW. The reason is that, since the antenna TA/RA and the rotor 5 are at a sufficiently close distance, peak shifts due to frequency modulation are negligible. In this example, too, a frequency modulated continuous wave FMCW is radiated while being subjected to modulation over the course of 1 millisecond, and then, at an interval of 1 millisecond, a next frequency modulated continuous wave FMCW is radiated. It is assumed that the modulation width is e.g. 250 MHz.

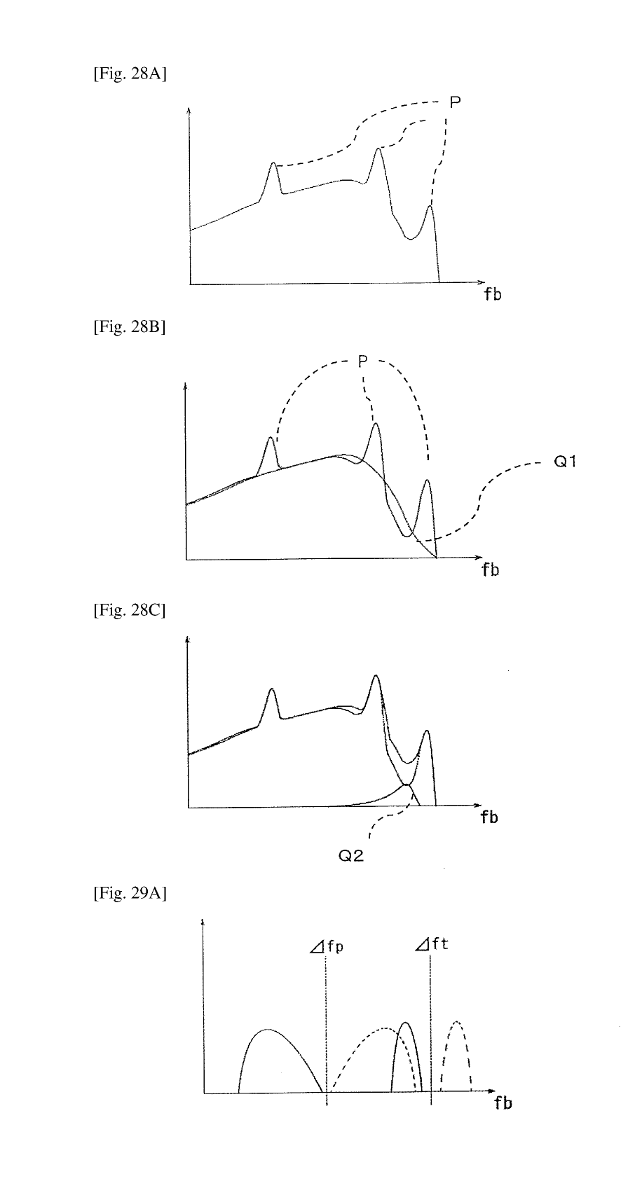

FIG. 28A shows exemplary beat signal waveforms when a frequency modulated continuous wave FMCW is transmitted. A peak corresponding to a far target has a narrow frequency span, which overlaps the broad frequency spectrum originating from the rotor 5.

FIG. 28B shows an exemplary frequency spectrum obtained by again radiating a frequency modulated continuous wave FMCW 1 millisecond after a given point in time. Since the radiation interval between the two frequency modulated continuous waves FMCW is only 1 millisecond, peaks P which correspond to distances from targets have hardly changed in position and size. On the other hand, the change in the angle of the rotor 5 has caused a shift in the broad frequency spectrum Q1 originating from the rotor 5.

When a difference is taken between the frequency spectrum of FIG. 28A and the frequency spectrum of FIG. 28B, the target-originated peak disappears; as for the rotor-originated broad peak, however, only its portion that has changed due to the shift remains. FIG. 28C shows a computed result Q2 of difference between the frequency spectrum of FIG. 28A and the frequency spectrum of FIG. 28B.

In this computation of spectrum difference, similarly to the computation associated with FIG. 23, the reception intensity calculation section 232 performs a process of detecting an edge that takes a maximum value. The largest edge corresponds to the rotor 5 appearing sideways (i.e., orthogonal to a line of sight) as viewed from the antenna TA/RA. By repeating signal wave radiation a plural number of times, with short time intervals therebetween, the reception intensity calculation section 232 is able to identify a moment when the edge of beat signal frequency becomes smallest, as in the case of continuous waves CW.

The aforementioned process is also applicable to large-sized multicopters, in which case the distance from the antenna TA/RA to a rotor 5 may not be negligible. Although the broad peak will shift toward higher frequencies due to the increased distance to the rotor 5, the distance to the rotor 5 is still invariable; therefore, moments when the edge takes a maximum value and a minimum value can be identified through the same procedure as above. In order to accurately know the number of revolutions, the distance to the rotor 5 may be previously measured (i.e., to make it known), and an adjustment may be made to bring the broad peak toward lower frequencies correspondingly to that distance.

Although the above examples illustrate methods which detect peak edges by utilizing beat signals that contain influences associated with Doppler shifts, this is not a limitation. Since a Doppler shift caused by a rotor 5 has a broad peak, it can be regarded as background noise. A frequency modulated continuous wave FMCW may be radiated a plural number of times, and a moment when the background level becomes lowest may be found.

Flowchart-based description of the aforementioned process is omitted.

The multicopter 1 includes a control unit(s) which controls rotor rotation, e.g., the microcontroller 20 and/or the ECUs 14 shown in FIG. 4. In order to communicate information concerning detected targets to the control unit(s), the radar system 10 is connected to the control unit(s) in one way or another. Taking advantage of this, conversely, the object detection apparatus 40 of the radar system 10 is arranged so as to be able to receive information concerning rotational control of each rotor from the control unit. Utilizing the rotation control information makes it easier for the object detection apparatus 40 to estimate or identify a number of revolutions of each rotor 5, which makes it easier to select moments when the rotor takes a position that results in the smallest solid angle. Note that the technique for receiving rotor control information from each control unit is also applicable to the method according to Embodiment 1.

The above-described process illustrates a process of identifying a moment when the edge of beat signal frequency (i.e., the highest frequency of the beat signal) becomes smallest. This explanation was based on the premise that the highest frequency of a beat signal is given by the frequency component of a reflected wave originating from the rotor 5. However, the inventors have noticed the possibility that, if the target is moving fast, for example, the frequency of a target-originated reflected wave may become higher than the frequency of a rotor-originated reflected wave. Even in that case, the signal processing circuit 44 of the object detection apparatus 40 may identify the frequency component of a reflected wave originating from the rotor 5, and utilize the identified frequency component in the process of identifying a moment at which the solid angle becomes equal to or smaller than the predetermined value. As a result of this, the signal processing circuit 44 is able to normally operate until finally acquiring the frequency of a target-originated reflected wave.

As described above, although a moment of smallest solid angle can be determined from a reflected wave obtained while applying frequency modulation, it is also possible to determine the moment of smallest solid angle from a reflected wave which is obtained while not applying frequency modulation. The process of determining such a moment is actually easier in a non-frequency modulation scenario, or in a scenario where a sweep rate obtained by dividing the frequency sweep width by the sweep time is small. On the other hand, in order to detect a distance between targets, it is necessary to receive reflected waves while applying frequency modulation with a certain sweep rate or above. Therefore, it is effective for the object detection apparatus 40 to perform processing by using two or more sweep rates, each obtained by dividing the frequency sweep width by the sweep time.

For example, let us assume that the transmission/reception circuit 42 of the object detection apparatus 40 is able to generate two signal waves based on sweep rates V1 and V2 (MHz/milliseconds) (where it is assumed that V1<V2). In identifying a moment of smallest solid angle, the transmission/reception circuit 42 generates the lower sweep rate V1. For identifying this moment, it is preferable that V1 is 0 or as close to 0 as possible. Once the moment when the solid angle becomes smallest has been identified, the transmission/reception circuit 42 radiates an FMCW with the higher sweep rate V2. Thus, the target identifying process can be performed with appropriate timing.

### Embodiment 3

In the present embodiment, the radar system 10 separates a reflected wave originating from a rotor 5 from a target-originated reflected wave, and by utilizing the target-originated reflected wave, performs signal processing for detecting a target. The present embodiment will mainly illustrate a process of separating between a reflected wave originating from a rotor 5 and a target-originated reflected wave. Once the target-originated reflected wave has been separated, the subsequent signal processing for target detection is as has been described above.

The (sweep) condition for a single frequency modulation of a frequency modulated continuous wave FMCW according to Embodiment 2, i.e., the amount of time required for modulation (sweep time), is 1 millisecond, with a modulation width of 250 MHz. However, the sweep time might be made as short as about 100 microseconds.

However, in order to realize the aforementioned sweep condition, not only the constituent elements related to transmission wave radiation, but also the constituent elements related to reception under the aforementioned sweep condition also need to rapidly operate. For example, it is necessary to provide an A/D converter 227 that rapidly operates under the aforementioned sweep condition (FIG. 14). The sampling frequency of the A/D converter 227 may be e.g. 10 MHz, but may be faster than 10 MHz. The circuit design for such a rapid-operating A/D converter 227 is generally not simple, and is likely to result in a low S/N ratio. The cost will of course be high. Under such circumstances, the aforementioned sweep condition will usually not be a choice. Nonetheless, the inventors have conducted studies based on the concept of adopting such constituent elements, and attained the following level of performance.

The inventors have concluded as follows through their studies.

First, it is assumed that the sweep time Tm=100 microseconds (100×10⁻⁶ seconds); the FMCW modulation width Wm=500 MHz (500×10⁶ Hz); and the tip of the rotor 5 had a maximum peripheral velocity Vp=119 m/s. Note that the largest value of peripheral velocity of the rotor 5 as illustrated in Embodiment 2 (Table 1) is exemplified here as the value of maximum peripheral velocity Vp.

Under the aforementioned condition, for a target at 1.8 m or farther away, the Doppler shift Δfd is smaller than any frequency difference Δfr that occurs with reciprocation of a signal wave (the process of deriving this relationship is omitted). Therefore, when an UP-beat signal wave is radiated for a rotor 5 that is rotating toward the antenna TA/RA, a still target which is 1.8 m or farther away can be distinguished from the rotor.

Next, a case will be considered where a target which is 1.8 m or farther away is approaching. In this case, when an UP-beat signal wave is radiated, the influence of a Doppler shift may make it impossible to distinguish between a reflected wave from the target and a reflected wave from a rotor 5. In other words, the target and a rotor 5 may not be distinguishable from each other.

However, assuming that the upper limit of the velocity with which the target approaches is 28 m/s (=100 km/h), the additional Doppler shift occurring in that case will be about 14 kHz. This corresponds to a beat frequency when an FMCW signal wave is transmitted to and received from a target at a distance of about 50 cm. Considering this value, it can be said that any target which is 2.3 m (=1.8 m+0.5 m) or farther away can be distinguished from a rotor 5.

In Embodiment 2 described above, it was explained that the position and/or radiation range of the transmission antenna TA is/are adjusted so that only one rotor can fit within the radiation range of each transmission antenna TA. This construction can also be adopted in the present embodiment. However, two rotors may fit within the monitored field of the radar system. For example, in a multicopter including an even number of (four or more) rotors, two rotors are to be placed at positions which are symmetric with respect to an axis along the heading (hereinafter, such two rotors will conveniently be referred to as “adjacent rotors”). Adjacent rotors are always rotating in opposite directions. Therefore, when the monitored field of the radar system is designed so as to contain adjacent rotors, the tips of the rotors are always moving away from or closer to the radar system. With such an arrangement, a Doppler shift of a reflected wave from a rotor will always be in the same direction. Stated otherwise, peaks are not scattered in the frequency spectra of beat signals originating from a rotor. Therefore, it can be easily distinguished from a target.

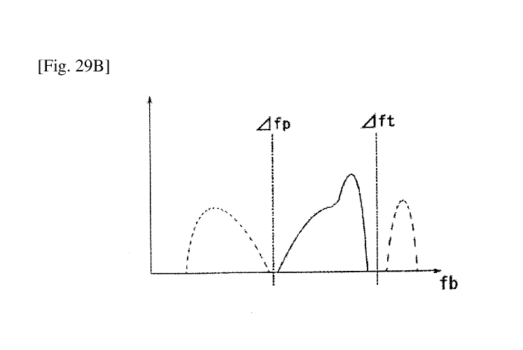

Next, FIG. 29A and FIG. 29B will be referred to.

First, following physical quantities are defined.

Δfp: A beat frequency (Hz) that occurs as a signal wave reciprocates to and from a rotor 5, which is a fixed value that is determined in accordance with the distance (fixed value) between the antenna TA/RA and the rotor 5.
Δft: A beat frequency (Hz) that occurs as a signal wave reciprocates to and from a target which is located in a minimum design detection range of the radar system 10.

FIG. 29A shows frequency spectra of various beat signals when a rotor 5 within a monitored field of the antenna TA/RA is positioned so as to rotate in a direction of approaching the antenna TA/RA. Each solid line curve represents an UP beat signal which is obtained in an UP beat period of increasing frequency. Each broken line curve represents a DOWN beat signal obtained in a DOWN beat period of decreasing frequency.

The solid line on the left side (meaning the “lower-frequency side”; the same terminology will apply hereinafter) of Δfp represents an exemplary frequency spectrum of an UP beat signal obtained by utilizing reflected waves originating from a rotor 5. Since the UP beat signal is generated based on reflected waves from minuscule points from the axis of rotation to each blade-tip of the rotor 5, which have respectively different rotational speeds, its frequency spectrum has a relatively broad frequency band.

The solid line on the left side of Δft shows an exemplary frequency spectrum of an UP beat signal obtained by utilizing a target-originated reflected wave, when the target is approaching the unmanned multicopter 1. It can be said that the frequency spectrum of the UP beat signal is distributed across a frequency band which is greater than Δfp and smaller than Δft. It is assumed that the target is at a position which is farther than the minimum design detection range of the radar system 10.

The UP beat signals are observed on the left side, alike, of Δfp and Δft respectively.

Next, the two broken lines in FIG. 29A will be described.

The broken line on the right side (meaning the “high-frequency side” of Δfp; the same terminology will apply hereinafter) represents an exemplary frequency spectrum of a DOWN beat signal obtained by utilizing reflected waves originating from a rotor 5. The broken line on the right side of Δft represents an exemplary frequency spectrum of a DOWN beat signal when the target is approaching the unmanned multicopter 1. They are observed on the right side, alike, of Δfp and Δft respectively.

As will be understood from the example of FIG. 29A, both the UP beat signal obtained by utilizing reflected waves originating from a rotor 5 and the UP beat signal obtained by utilizing a target-originated reflected wave have their respective frequency spectra appearing on either the left side or the right side, alike, of Δfp and Δft. In other words, the regions in which their frequency peaks appear do not overlap each other, thereby making it easy to distinguish between them. Thus, processing is easier when a rotor 5 within the monitored field of the antenna TA/RA is positioned so as to rotate in a direction of approaching the antenna TA/RA.

Through the above-described process, it is possible to extract only the frequency spectrum of an UP beat signal associated with a target-originated reflected wave, detect the peak corresponding to the target, and determine a distance to the target. As for the relative velocity, in the present embodiment, it is calculated by a method which is different from the earlier-described method. The explanation thereof will be given later.

Next, FIG. 29B is referred to.

FIG. 29B shows various beat signals when a rotor 5 within a monitored field of an antenna TA/RA is positioned so as to rotate in a direction away from the antenna TA/RA. The solid and broken line curves are similarly defined as in the example of FIG. 29A. In other words, the solid line curve represents an UP beat signal obtained in an UP beat period of increasing frequency, whereas each broken line curve represents a DOWN beat signal obtained in a DOWN beat period of decreasing frequency.

When paying attention to the solid line, it will be seen that an UP beat signal obtained by utilizing reflected waves originating from a rotor 5, appearing on the right side of Δfp, and an UP beat signal obtained by utilizing a target-originated reflected wave, appearing on the left side of Δft, have overlapping frequency spectra. It is assumed that the target is approaching the unmanned multicopter 1. When the rotor 5 within the monitored field of the antenna TA/RA is positioned so as to rotate in a direction away from the antenna TA/RA, it is more likely for the two UP beat signals to have overlapping frequency spectra.

On the other hand, the frequency spectra of the two DOWN beat signals represented by the broken lines appear separately on the left side of Δfp and on the right side of Δft. Therefore, the two DOWN beat signals can be separately identified.

Furthermore, by using the separated DOWN beat signals, it also becomes possible to separate between the UP beat signals. For example, an UP beat signal and a DOWN beat signal that are obtained by utilizing reflected waves originating from a rotor 5 will appear substantially symmetrically with respect to Δfp in the center. Therefore, for example, the frequency spectrum of the DOWN beat signal appearing on the left side of Δfp may be extracted, and this frequency spectrum may be folded back toward the higher frequency side with respect to Δfp in the center. As a result of this, the frequency spectrum of the UP beat signal appearing on the right side of Δfp, obtained by utilizing reflected waves originating from a rotor 5, is acquired. Furthermore, the acquired frequency spectrum may be subtracted from the frequency spectrum (solid line) of the signal which is really composed of two overlapping UP beat signals. As a result of this, the frequency spectrum of the UP beat signal obtained by utilizing a target-originated reflected wave, appearing on the left side of Δft, can also be acquired.

Through the above-described process, it is possible to extract only the frequency spectrum of an UP beat signal associated with a target-originated reflected wave, detect the peak corresponding to the target, and determine a distance to the target. The method of relative velocity calculation will be described later.

Because each peak of the frequency spectrum of the UP beat signal corresponds to the target, this peak is what is being sought. The following method allows only a peak(s) to be acquired from within the frequency spectrum of the UP beat signal obtained by utilizing a target-originated reflected wave. Specifically, from the overlapping frequency spectrum (solid line) appearing between Δfp and Δft, any broad peak is removed as the background noise. A “broad peak” means a peak which lacks a predefined intensity. In FIG. 29B, the predefined intensity may be set to a value which allows a peak of the frequency spectrum represented by the solid line to be distinguished from any other peak. This allows only the peak of the UP beat signal obtained by utilizing a target-originated reflected wave to be extracted.

In FIG. 29A and FIG. 29B, it is assumed by approximation that, changes in the position of the rotor due to its rotation since an UP beat radar wave begins to be radiated and until a DOWN beat radar wave finishes being radiated is negligible.

The inventors have sought conditions to be satisfied in order for the frequency region in which the frequency peak of a beat signal obtained by utilizing reflected waves originating from a rotor 5 appears and the frequency region in which the frequency peak of a beat signal obtained by utilizing a target-originated reflected wave appears to be separated in the first place. The following is the conclusion thereof.

First, following physical quantities are defined.

Δfp: A beat frequency (Hz) that occurs as a signal wave for transmission/reception reciprocates to and from a rotor 5.
Δfpd: A frequency (Hz) corresponding to a Doppler shift which occurs due to rotation of the rotor 5.
Δft: A beat frequency (Hz) that occurs as a signal wave reciprocates to and from a target.
Δftd: A frequency (Hz) corresponding to a Doppler shift which occurs due to the target having a relative velocity.

Note that C in the following description is the speed at which a transmission wave (an electromagnetic wave) propagates in a vacuum, which is equal to the velocity of light.

The condition to be satisfied in order for the frequency region in which the frequency peak of an UP beat signal obtained by utilizing reflected waves originating from a rotor 5 appears and the frequency region in which the frequency peak of an UP beat signal obtained by utilizing a target-originated reflected wave appears not to overlap, as illustrated by the example of FIG. 29A, is as follows.

Δfₜ−Δf_{td}>Δfₚ+Δf_{pd} [eq. 3]

The condition of eq. 3 is to be satisfied at the lower limit of detection distance. As used herein, “the lower limit of detection distance” implies that a target which is detectable to the radar system 10 has come closest to the unmanned multicopter 1. At any position farther than the lower limit of detection distance, eq. 3 will be automatically satisfied anyway.

Now, conditions further narrowing down on eq. 3 will be discussed. In the aforementioned state where the target has come closest to the unmanned multicopter 1, the relative velocity between the target and the unmanned multicopter 1 may be regarded as very small. If the approaching target still had a large relative velocity at this point, it would be impossible to avoid the target, even if such a target were detected by the radar system 1; this makes it rational to stipulate the condition Δftd=0. Thus, eq. 3 can be simplified into eq. 4.

$$Δ {f}_{t} > Δ {f}_{p} + Δ {{f}_{pd} \\ ( Δ {f}_{t} )}_{min} = \frac{2 {RW}_{m}}{{CT}_{m}} Δ {f}_{p} = \frac{2 {LW}_{m}}{{CT}_{m}} Δ {f}_{pd} = \frac{2 {Fv}_{p}}{C} \qquad [ eq . 4 ]$$

In the above, following physical quantities are defined.

F: radar wave frequency (Hz)
Wm: FMCW modulation width (Hz)
Tm: sweep time (second), which may also be referred to modulation time.
R: minimum design detection range of the radar system 10 (m)
V: relative velocity between the unmanned multicopter 1 and the target
L: distance from the antenna TA/RA to the center (center of gyration) of the rotor 5 (m)
Vp: maximum peripheral velocity of the tip of the rotor 5 (m/sec)

Note that (Δft)min and Δfp above are values in the case where the modulated wave has a waveform composed of an UP beat and a DOWN beat. As will be described later, when the sweep time Tm of the modulated wave is as short as about 100 microseconds, a method which calculates a distance and a relative velocity by using only either one of the UP beat or the DOWN beat, rather than by using both the UP beat and the DOWN beat, is adopted. In such a case, Δft and Δfp are expressed by eq. 5 as follows.

$${( Δ {f}_{t} )}_{min} = \frac{{RW}_{m}}{{CT}_{m}} Δ {f}_{p} = \frac{{LW}_{m}}{{CT}_{m}} \qquad [ eq . 5 ]$$

From eq. 4 or eq. 5, the minimum detection range R expressed by eq. 6 below is obtained. The former inequality is the minimum detection range derived from eq. 4, whereas the latter inequality is the minimum detection range derived from eq. 4 and eq. 5.

$$R > L + \frac{{FV}_{p} {T}_{m}}{{W}_{m}} or R > L + \frac{2 {FV}_{p} {T}_{m}}{{W}_{m}} \qquad [ eq . 6 ]$$

Once the minimum detection range R and the maximum peripheral velocity Vp of the rotor are determined, then it becomes possible to choose F, Tm and Wm that satisfy eq. 6. As a result, the frequency region in which the frequency peak of a beat signal obtained by utilizing reflected waves originating from a rotor 5 appears and the frequency region in which the frequency peak of a beat signal obtained by utilizing a target-originated reflected wave appears are separated.

Note that there is no practical problem if the minimum detection range R is about 3 m. However, in order to detect a target which is at an even closer position, the largest diameter S(m) of the multicopter, including the span of rotation of the rotor, might serve as an appropriate index, for example. Eq. 6 can be further transformed into eq. 7. The former and latter inequalities in eq. 7 are similar to those in the example of eq. 6.

$$S > L + \frac{{FV}_{p} {T}_{m}}{{W}_{m}} or S > L + \frac{2 {FV}_{p} {T}_{m}}{{W}_{m}} \qquad [ eq . 7 ]$$

On the other hand, as shown in the example of FIG. 29B, the condition for the frequency region in which the frequency peak of a beat signal obtained by utilizing reflected waves originating from a rotor 5 appears and the frequency region in which the frequency peak of a beat signal obtained by utilizing a target-originated reflected wave appears to overlap may simply be that the relationship of eq. 8 below be satisfied.

Δft>Δfp (eq. 8)

R>L (eq. 9)

Note that eqs. 6, 7 and 9 include the distance L from the antenna TA/RA to the center of the rotor 5. Usually, a positioning such that the center of the rotor 5 stays out of the field of view of the radar system 10 as much as possible is to be selected. The reason why L is nonetheless employed in eq. 6 is that L can be considered as a clear and appropriate index of the distance between the antenna TA/RA and the rotor 5.

Eq. 9 does not stipulate an upper limit for the minimum detection range R. The reason is that eq. 9 only expresses a condition that is necessary for being able to distinguish between rotor-originated reflected waves and target-originated reflected waves. To this end, the minimum detection range R is preferably set as large as possible; in practice, however, the minimum detection range R is to be kept moderate. For example, it is considered practical that the minimum detection range R is equal to or less than ten times the largest diameter S(m) of the multicopter. Since the distance L from the antenna TA/RA to the center of the rotor 5 does not exceed the largest diameter S of the multicopter, (FVₚTₘ)/Wₘ or (2FVₚTₘ)/Wₘ in the second term on the right-hand side of eq. 6 may be set equal to or less than ten times S, whereby the minimum detection range R will also be kept to a similar value. For instance, when F=76.5 (GHz); Vp=120 (m/sec); Tm=100 (μsec); and Wm=500 (MHz), (FVₚTₘ)/Wₘ is 1.84 (m). In this case, a minimum detection range R of 3 m or less can be realized even in a radar system to be mounted in a multicopter having a largest diameter S of 1 m.

In the above description, the peripheral velocity of the rotor 5 is assumed to be 119 m/s. This peripheral velocity is envisaged as a state where, as indicated in Table 2, the rotor 5 is rotating at the fastest rate. The state where the rotor 5 is rotating at the fastest rate can be considered as a state where the unmanned multicopter 1 is flying at the maximum velocity.

TABLE 2

| modulation | modulation | peripheral | | | |
|---|---|---|---|---|---|
| width | time | velocity | Δfd | distance | Δfr |
| (MHz) | (msec) | (m/sec) | (kHz) | (m) | (kHz) |
| 250 | 1.0 | 119 | 60.69 | 36 | 60.0 |
| 250 | 1.0 | 20 | 10.2 | 6 | 10.0 |
| 500 | 0.1 | 119 | 60.69 | 1.9 | 63.3 |

On the other hand, when the velocity of travel is small, etc., it can be said that the rotor 5 is rotating at a lower number of revolutions. In such a situation, under the modulation conditions as described above, it is possible to measure the distance of a target in an even closer range. When the rotational speed of the rotor has been identified by the method described in Embodiment 2, the closest distance at which to detect the target may be dynamically varied in accordance with that velocity.

As mentioned above, under the modulation conditions that the sweep time is 100 microseconds and the modulation width is 500 MHz, the circuit design for achieving digital conversion of beat signals from signals which have been transmitted and received is generally not simple, and is likely to result in a low S/N ratio. Therefore, for example, modulation over a period of 100 microseconds may be repeated ten times, and respective results of AD conversion may be added up to obtain an improved S/N ratio.

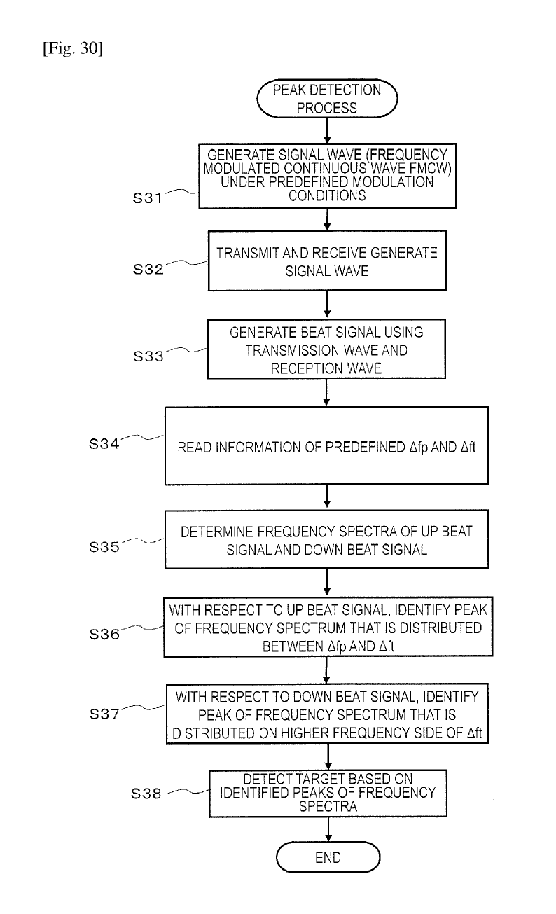

Next, with reference to FIG. 30, a procedure of processing by the object detection apparatus 40 of the radar system 10 will be described. In actual implementation, it is preferable that the processing be simplified. Therefore, under conditions of a relationship corresponding to FIG. 29A, a process of the case where the target is approaching, or the case where the relative velocity between the multicopter 1 and the target is zero, will be described herein.

FIG. 30 is a flowchart showing a procedure of processing of separating between a reflected wave originating from a rotor 5 and a target-originated reflected wave according to the present embodiment.

At step S31, the triangular wave/CW wave generation circuit 221 generates a frequency modulated continuous wave FMCW, which is a signal wave, under predefined modulation conditions (sweep time and modulation width).

At step S32, the transmission antenna TA radiates the generated signal wave, and the reception antenna RA receives reflected waves. Note that the process of step S31 and the process of step S32 may be performed in parallel, respectively by the triangular wave/CW wave generation circuit 221 and the antenna TA/RA. It is not necessary that step S22 be performed after completion of step S21.

At step S33, each mixer 224 generates a beat signal by using the transmission wave and the reception wave.

At step S34, the reception intensity calculation section 232 reads Δfp and Δft as predetermined values (variables), from an internal buffer (not shown) or the memory 231.

At step S35, the reception intensity calculation section 232 applies Fourier transform to an UP beat signal and a DOWN beat signal to determine their respective frequency spectra.

At step S36, with respect to the UP beat signal, the reception intensity calculation section 232 determines a peak of the frequency spectrum that is distributed between Δfp and Δft.

At step S37, with respect to the DOWN beat signal, the reception intensity calculation section 232 determines a peak of the frequency spectrum that is distributed on the higher frequency side of Δft.

At step S38, the reception intensity calculation section 232 detects a target based on the identified peaks of the frequency spectra. Since the details of step S38 have been described in “2.2.2. object detection apparatus” above, and its description will not be repeated.

Next, a method of calculating a relative velocity between the multicopter 1 and the target according to the present embodiment will be described.

The above description illustrates that the velocity detection section 234 of FIG. 14 calculates the relative velocity V according to the following equation, based on beat frequencies fu and fd.

V={C/(2·f0)}·{(fu−fd)/2}

The term (fu−fd)/2 on the right-hand side is a frequency component based on a Doppler shift due to the relative velocity between the antenna TA/RA and the target.

In the present embodiment, without utilizing any frequency component based on a Doppler shift, a relative velocity between the multicopter 1 and the target is calculated. In the present embodiment, the sweep time is Tm=100 microseconds, which is very short. The lowest detect able frequency of a beat signal is 1/Tm. In the case where Tm=100 microseconds, the lowest detect able frequency of a beat signal is 10 kHz. This frequency would correspond to a Doppler shift of a reflected wave from a target that has a relative velocity of about 20 m/s. In other words, so long as one relies on a Doppler shift, it would be impossible to detect a relative velocity of 20 m/s or less. Therefore, the inventors have found that it would be preferable to adopt a calculation method which is distinct from any Doppler shift-based calculation method.

As an example, the present embodiment illustrates a process that utilizes a signal (UP beat signal) representing a difference between a transmission wave and a reception wave, which is obtained in an UP beat period where the transmission wave increases in frequency. A single sweep time of FMCW is 100 microseconds, and its waveform sawtooth shape which is composed only of an UP beat portion. In other words, in the present embodiment, the signal wave which is generated by the triangular wave/CW wave generation circuit 221 has a sawtooth shape. The sweep width in frequency is 500 MHz. Since no peaks are to be utilized that are associated with Doppler shifts, the process is not one that generates an UP beat signal and a DOWN beat signal to look into peak combinations, but will rely on only one of such signals.

The filters 225 remove frequency components of 60 kHz or less. In the present embodiment, the peripheral velocity of the rotor is 120 m/s at the most, and the Doppler shift at this value is 60 kHz. By removing components of 60 kHz or less, Doppler shifts associated with the rotors can be completely removed. Note that 60 kHz corresponds to a beat signal frequency of the case where the distance to the target is 2 m. Therefore, although targets that are at 2 m or any closer position cannot be detected by the radar system 10 of the present embodiment, there is no practical problem.

The A/D converter 227 (FIG. 14) samples each UP beat signal at a sampling frequency of 10 MHz, and outputs several hundred pieces of digital data (hereinafter referred to as “sampling data”). The sampling data is generated based on upbeat signals after a point in time where a reception wave is obtained and until a point in time at which a transmission wave completes transmission, for example. Note that the process may be ended as soon as a certain number of pieces of sampling data are obtained.

In the present embodiment, as an example, 128 upbeat signals are transmitted/received in series, for each of which some several hundred pieces of sampling data are obtained. The number of upbeat signals is not limited to 128. It may be 256, or 8. An arbitrary number may be selected depending on the purpose.

The resultant sampling data is stored to the memory 231. The reception intensity calculation section 232 applies a two-dimensional fast Fourier transform (FFT) to the sampling data. Specifically, first, for each of the sampling data pieces that have been obtained through a single sweep, a first FFT process (frequency analysis process) is performed to generate a power spectrum. Next, the velocity detection section 234 performs a second FFT process for the processing results that have been collected from all sweeps.

When the reflected waves are from the same target, peak components in the power spectrum to be detected in each sweep period will be of the same frequency. On the other hand, for different targets, the peak components will differ in frequency. Through the first FFT process, plural targets that are located at different distances can be separated.

In the case where the relative velocity between the multicopter 1 and the target is non-zero, the phase of the upbeat signal changes slightly from sweep to sweep. In other words, through the second FFT process, a power spectrum whose elements are the data of frequency components that are associated with such phase changes will be obtained for the respective results of the first FFT process.

The reception intensity calculation section 232 extracts peak values in the second power spectrum above, and sends them to the velocity detection section 234.

The velocity detection section 234 determines a relative velocity from the phase changes. For example, suppose that a series of obtained upbeat signals undergo phase changes by every phase θ [rad]. Assuming that the transmission wave has an average wavelength λ, this means there is a λ/(4π/θ) change in distance every time an upbeat signal is obtained. Since this change has occurred over an interval of upbeat signal transmission Tm (=100 microseconds), the relative velocity is determined to be {λ/(4π/θ)}/Tm.

Through the above processes, a relative velocity between the multicopter 1 and the target can be determined. Note that, during the course of relative velocity determination in the aforementioned process, a distance between the multicopter 1 and the target can also be determined.

### Embodiment 4

In the present embodiment, the radar system 10 utilizes continuous waves CW of one or more frequencies to ignore or remove the influence of reflected waves originating from a rotor(s) 5. Then the radar system 10 utilizes a target-originated reflected wave(s) to perform signal processing for detecting a target. Hereinafter, a process of separating between a reflected wave originating from a rotor and a target-originated reflected wave will mainly be described. Once a target-originated reflected wave has been separated, the subsequent signal processing for target detection is as has been described above. Similarly to the description of Embodiment 2, description of the present embodiment will also refer to any continuous wave to be utilized in the CW method as a “continuous wave CW”. As described earlier, a continuous wave CW has a constant frequency, and is not modulated.

Unlike in the FMCW method, the CW method works in such a manner that any frequency difference to occur between a transmission wave and a reception wave is due only to a Doppler shift. That is, the frequency of any peak that appears in a beat signal is solely dependent on Doppler shifts.

The frequency of a beat signal which is obtained from a transmission wave and a reflected wave originating from a rotor 5 is usually much higher than the frequency of a beat signal which is obtained from a transmission wave and a target-originated reflected wave. Therefore, both are clearly distinguishable from each other. Moreover, by using the latter beat signal, a relative velocity can be identified. Specifically, any beat signal that appears on the lower frequency side of a threshold frequency may be determined as a target-originated beat signal B_{TG}; therefore, this can be used in determining a relative velocity between the multicopter and the target. Note that the “peripheral velocity of a rotor 5” means the peripheral velocity of the blade-tip of the rotor 5.

Given that the maximum flight speed of the multicopter can only be a little above 100 km/h, this flight speed translates approximately to 27.8 meters per second, which is still lower than the rotational speed of 1000 rpm in Table 1, for example. Therefore, without being influenced by the beat signals B_{cw1} to B_{cw3}, a relative velocity between the multicopter and the target can be determined from the beat signal B_{TG} alone. Although it may be conceivable that the multicopter is capable of flying at a flight speed above 140 km/h, the rotational speed of a rotor in such a case is expected to be much faster than 40 m/s; therefore, a relative velocity between the multicopter and the target can be determined from the beat signal B_{TG} alone. In other words, in most applications, there is presumably no problem in adopting a fixed value for the threshold frequency with which to distinguish a target-originated peak from a rotor-originated peak.

In order to better ensure operation under a wide variety of flight conditions, it is preferable to dynamically change the threshold value in accordance with the peripheral velocity of the rotor. For example, the minimum-value edge E_{cw1} among the aforementioned frequency spectra of beat signals, or a value which is lower by a predetermined frequency than E_{cw1}, may be adopted as the threshold value. Before the multicopter makes a takeoff, the only frequency peaks to be detected would be frequency peaks originating from the rotors. By identifying frequency peaks originating from the rotors prior to takeoff, and consecutively updating the position while subsequently tracking rotor-originated peaks based on changing numbers of revolutions, the edge E_{cw1} can be more reliably identified. In this manner, the threshold value can be dynamically changed.

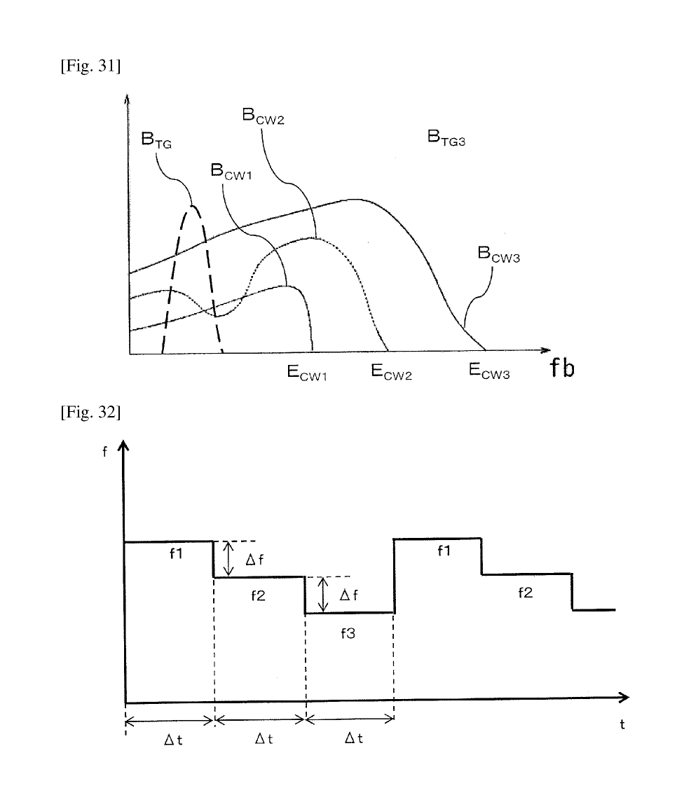

FIG. 31 shows frequency spectra of three beat signals B_{CW1} to B_{CW3} which are respectively obtained from continuous waves CW and three reflected waves originating from a rotor(s) 5, and a frequency spectrum of a beat signal B_{TG} obtained from a continuous wave CW and a target-originated reflected wave. The exemplary waveforms shown in FIG. 23 are conveniently exemplified here as the beat signals B_{CW1} to B_{CW3}. In other words, the beat signals B_{CW1} and B_{CW3} are the smallest waveform and the largest waveform, respectively, among the detected beat signal waveforms. With rotation of the rotor 5, the beat signal undergoes periodical changes, such that 1 cycle consists of B_{CW1}, B_{CW2}, B_{CW3}, B_{CW2}, and B_{CW1}. Note that the changes are gradual. The beat signal B_{CW2} is an example of a beat signal which is changing between the beat signals B_{CW1} and B_{CW3}.

On the other hand, with a broken line, FIG. 31 shows the frequency spectrum of the beat signal B_{TG} corresponding to the target. The frequency spectrum of the beat signal B_{TG}, obtained from the continuous wave CW and a target-originated reflected wave, will appear overlapping the frequency spectrum of the beat signal which is obtained from the continuous wave CW and the reflected waves originating from the rotor 5.

If the relative velocity between the multicopter 1 and each target is substantially constant, the waveform and peak frequency of the beat signal B_{TG} will also appear in substantially fixed manners. For example, by using a first order differential filter or a differential filter of the second order or above as was described in connection with Embodiment 1, it will become easier to identify the peak frequencies of the beat signals B_{TG1} to B_{TG3}. Other filters may also be adopted so long as they are capable of passing steep peaks.

Alternatively, by using as the threshold value the minimum-value edge E_{cw1} among the frequency spectra of beat signals obtained from the continuous wave CW and the reflected waves originating from the rotor 5, only those peak frequencies which are at frequencies lower than this threshold value and which have an amplitude value equal to or greater than a predefined amplitude may be extracted. As a result, beat signal frequencies can be identified.

Through the above process, the beat signal B_{TG} can be distinguished from the periodically-fluctuating beat signals B_{CW1} to B_{CW3}. While ignoring or removing the beat signals B_{CW1} to B_{CW3}, the radar system 10 is able to determine a relative velocity between the multicopter 1 and each target, by looking only at the beat signal B_{TG}.

Specific details are as follows.

Suppose that the radar system 10 has emitted a continuous wave CW of a frequency fp, and detected a reflected wave of a frequency fq that has been reflected off a target. The difference between the transmission frequency fp and the reception frequency fq is called a Doppler frequency, which approximates to fp−fq=2·Vr·fp/c. Herein, Vr is a relative velocity between the radar system and the target, and c is the velocity of light. The transmission frequency fp, the Doppler frequency (fp−fq), and the velocity of light c are known. Therefore, from this equation, the relative velocity Vr=(fp−fq)·c/2fp can be determined.

When it is necessary to detect not only a relative velocity between the multicopter 1 and the target but also a distance to the target, a 2 frequency CW method is adopted. In the 2 frequency CW method, continuous waves CW of two frequencies which are slightly apart are emitted each for a certain period, and their respective reflected waves are acquired. For example, in the case of using frequencies in the 76 GHz band, the difference between the two frequencies would be several hundred kHz. As will be described later, it is more preferable to determine the difference between the two frequencies while taking into account the minimum distance at which the radar used is able to detect a target.

Suppose that the radar system 10 has sequentially emitted continuous waves CW of frequencies fp1 and fp2 (fp1<fp2), and that the two continuous waves CW have been reflected off a single target, resulting in reflected waves of frequencies fq1 and fq2 being received by the radar system 10.

Based on the continuous wave CW of the frequency fp1 and the reflected wave (frequency fq1) thereof, a first Doppler frequency is obtained. Based on the continuous wave CW of the frequency fp2 and the reflected wave (frequency fq2) thereof, a second Doppler frequency is obtained. The two Doppler frequencies have substantially the same value. However, due to the difference between the frequencies fp1 and fp2, the complex signals of the respective reception waves differ in phase. By utilizing this phase information, a distance (range) to the target can be calculated.

Specifically, the radar system 10 is able to determine the distance R as R=c·Δφ/4π(fp2−fp1). Herein, Δφ denotes the phase difference between two beat signals, i.e., a beat signal fb1 which is obtained as a difference between the continuous wave CW of the frequency fp1 and the reflected wave (frequency fq1) thereof and a beat signal fb2 which is obtained as a difference between the continuous wave CW of the frequency fp2 and the reflected wave (frequency fq2) thereof. The method of identifying the frequencies fb1 and fb2 of the respective beat signals is identical to that in the aforementioned instance of a beat signal from a continuous wave CW of a single frequency.

Note that a relative velocity Vr under the 2 frequency CW method is determined as follows.

Vr=fb1·c/2·fp1 or Vr=fb2·c/2·fp2

Moreover, the range in which a distance to a target can be uniquely identified is limited to the range defined by Rmax<c/2(fp2−fp1). The reason is that beat signals resulting from a reflected wave from any farther target would produce a Δφ which is greater than 2π, such that they are indistinguishable from beat signals associated with targets at closer positions. Therefore, it is more preferable to adjust the difference between the frequencies of the two continuous waves CW so that Rmax becomes greater than the maximum detectable distance of the radar. In the case where a radar whose maximum detectable distance is 100 m is mounted on the multicopter, fp2−fp1 may be made e.g. 1.0 MHz. In this case, Rmax=150 m, so that a signal from any target from a position beyond Rmax is not detected. In the case of mounting a radar which is capable of detection up to 250 m, fp2−fp1 may be made e.g. 500 kHz. In this case, Rmax=300 m, so that a signal from any target from a position beyond Rmax is not detected, either. In the case where the radar mounted on the multicopter has both of an operation mode in which the maximum detectable distance is 100 m and the horizontal viewing angle is 120 degrees and an operation mode in which the minimum detectable distance is 250 m and the horizontal viewing angle is 5 degrees, it is preferable to switch the fp2−fp1 value be 1.0 MHz and 500 kHz for operation in the respective operation modes. The space in front of the multicopter during flight may often contain no target that interrupts radio waves, far and wide; in such cases, a large number of reflected waves from positions beyond Rmax may arrive. Selecting the value of fp2−fp1 in the aforementioned manner will be especially effective in avoiding such situations.

Note that the detection principle of the 2 frequency CW method imposes the constraint that, when a plurality of targets having an identical relative velocity exist at different positions, distances to the individual targets cannot be calculated. However, when one considers the manner in which a multicopter flying above in the air will be utilized, the relative velocities between the multicopter and still objects on the ground are all equal. This fact makes multiple-frequency CW useful. Note that the aforementioned value of Δfp may be determined by taking into consideration the detection distance of the radar, similarly to the above.

A detection approach is known which, by transmitting continuous waves CW at N different frequencies (where N is an integer of 3 or more), and utilizing phase information of the respective reflected waves, detects a distance between the multicopter 1 and each target. Under this detection approach, distance can be properly recognized up to N−1 targets. As the processing to enable this, a fast Fourier transform (FFT) is used, for example. Given N=64 or 128, an FFT is performed for sampling data of a beat signal as a difference between a transmission signal and a reception signal for each frequency, thus obtaining a frequency spectrum (relative velocity). Thereafter, at the frequency of the CW wave, a further FFT is performed for peaks of the same frequency, thus to derive distance information.

Hereinafter, this will be described more specifically.

For ease of explanation, first, an instance will be described where signals of three frequencies f1, f2 and f3 are transmitted while being switched over time. It is assumed that f1>f2>f3, and f1−f2=f2−f3=Δf. A transmission time Δt is assumed for the signal wave for each frequency. FIG. 32 shows a relationship between three frequencies f1, f2 and f3.

Via the transmission antenna TA, the triangular wave/CW wave generation circuit 221 (FIG. 14) transmits continuous waves CW of frequencies f1, f2 and f3, each lasting for the time Δt. The reception antennas RA receive reflected waves resulting by the respective continuous waves CW being reflected off one or plural targets.

Each mixer 224 mixes a transmission wave and a reception wave to generate a beat signal. The A/D converter 227 converts the beat signal, which is an analog signal, into several hundred pieces of digital data (sampling data), for example.

Using the sampling data, the reception intensity calculation section 232 performs FFT computation. Through the FFT computation, frequency spectrum information of reception signals is obtained for the respective transmission frequencies f1, f2 and f3.

Thereafter, the reception intensity calculation section 232 separates peak values from the frequency spectrum information of the reception signals. The frequency of any peak value which is predetermined or greater is in proportion to a relative velocity between the multicopter 1 and a target. Separating a peak value(s) from the frequency spectrum information of reception signals is synonymous with separating one or plural targets with different relative velocities.

Next, with respect to each of the transmission frequencies f1 to f3, the reception intensity calculation section 232 measures spectrum information of peak values of the same relative velocity or relative velocities within a predefined range.

Now, consider a scenario where two targets A and B exist which have about the same relative velocity but are at respectively different distances from the multicopter 1. A transmission signal of the frequency f1 will be reflected from both of targets A and B to result in reception signals being obtained. The reflected waves from targets A and B will result in substantially the same beat signal frequency. Therefore, the power spectra at the Doppler frequencies of the reception signals, corresponding to their relative velocities, are obtained as a synthetic spectrum F1 into which the power spectra of two targets A and B have been merged.

Similarly, for each of the frequencies f2 and f3, the power spectra at the Doppler frequencies of the reception signals, corresponding to their relative velocities, are obtained as a synthetic spectrum F1 into which the power spectra of two targets A and B have been merged.

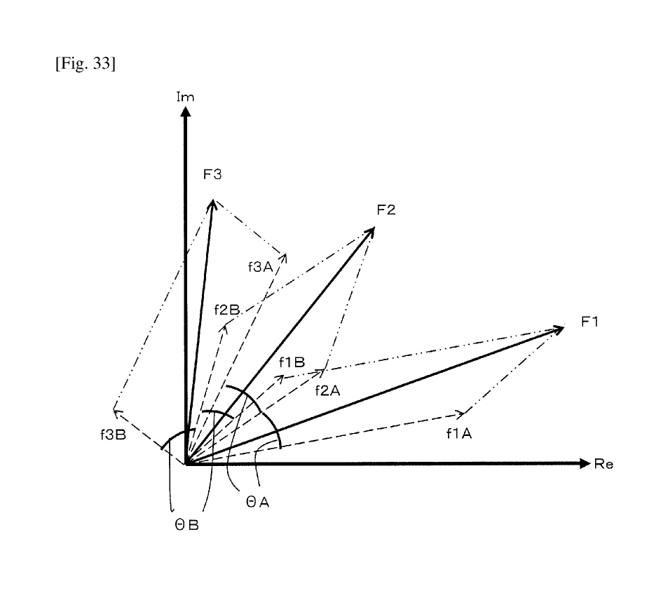

FIG. 33 shows a relationship between synthetic spectra F1 to F3 on a complex plane. In the directions of the two vectors composing each of the synthetic spectra F1 to F3, the right vector corresponds to the power spectrum of a reflected wave from target A; i.e., vectors f1A, f2A and f3A, in FIG. 33. On the other hand, in the directions of the two vectors composing each of the synthetic spectra F1 to F3, the left vector corresponds to the power spectrum of a reflected wave from target B; i.e., vectors f1B, f2B and f3B in FIG. 33.

Under a constant difference Δf between the transmission frequencies, the phase difference between the reception signals corresponding to the respective transmission signals of the frequencies f1 and f2 is in proportion to the distance to a target. Therefore, the phase difference between the vectors f1A and f2A and the phase difference between the vectors f2A and f3A are of the same value OA, this phase difference OA being in proportion to the distance to target A. Similarly, the phase difference between the vectors f1B and f2B and the phase difference between the vectors f2B and f3B are of the same value θB, this phase difference θB being in proportion to the distance to target B.

By using a well-known method, the respective distances to targets A and B can be determined from the synthetic spectra F1 to F3 and the difference Δf between the transmission frequencies. This technique is disclosed in U.S. Pat. No. 6,703,967, for example. The entire disclosure of this publication is incorporated herein by reference.

Similar processing is also applicable when the transmitted signals have four or more frequencies.

Note that, before transmitting continuous waves CW at N different frequencies, a process of determining the distance and relative velocity between the multicopter 1 and each target may be performed by the 2 frequency CW method. Then, under predetermined conditions, this process may be switched to a process of transmitting continuous waves CW at N different frequencies. For example, FFT computation may be performed by using the respective beat signals at the two frequencies, and if the power spectrum of each transmission frequency undergoes a change over time of 30% or more, the process may be switched. The amplitude of a reflected wave from each target undergoes a large change over time due to multipath influences and the like. When there exists a change of a predetermined magnitude or greater, it may be considered that plural targets may exist.

Moreover, the CW method is known to be unable to detect a target when the relative velocity between the radar system and the target is zero, i.e., when the Doppler frequency is zero. However, when a pseudo Doppler signal is determined by the following methods, for example, it is possible to detect a target by using that frequency.

(Method 1) A mixer that causes a certain frequency shift in the output of a receiving antenna is added. By using a transmission signal and a reception signal with a shifted frequency, a pseudo Doppler signal can be obtained.

(Method 2) A variable phase shifter to introduce phase changes continuously over time is inserted between the output of a receiving antenna and a mixer, thus adding a pseudo phase difference to the reception signal. By using a transmission signal and a reception signal with an added phase difference, a pseudo Doppler signal can be obtained.

An example of specific construction and operation of inserting a variable phase shifter to generate a pseudo Doppler signal under Method 2 is disclosed in Japanese Laid-Open Patent Publication No. 2004-257848. The entire disclosure of this publication is incorporated herein by reference.

When targets with zero or very little relative velocity with respect to the multicopter 1 need to be detected, the aforementioned processes of generating a pseudo Doppler signal may be adopted, or the process may be switched to a target detection process under the FMCW method. When using the FMCW method, according to the method described in the above embodiment, influences of reflected waves originating from the rotors 5 can be eliminated. During low-speed flight, or while the altitude is being decreased to make a landing, the rotational speed of the rotors will be lowered; therefore, without performing any special processes, it may well be possible for a target to be detectable by the FMCW method.

Note that the relative velocity between the multicopter 1 and the target being zero means that collision between the multicopter 1 and the target will not occur. Therefore, inability to detect a target with zero relative velocity may not be much of a practical issue. Moreover, considering the flying environment of the multicopter 1, it is expected that there is basically no such target that will come to zero relative velocity during flight. Therefore, it may not present much of an operational issue to decide that targets with zero relative velocity are not subjects of detection, either.

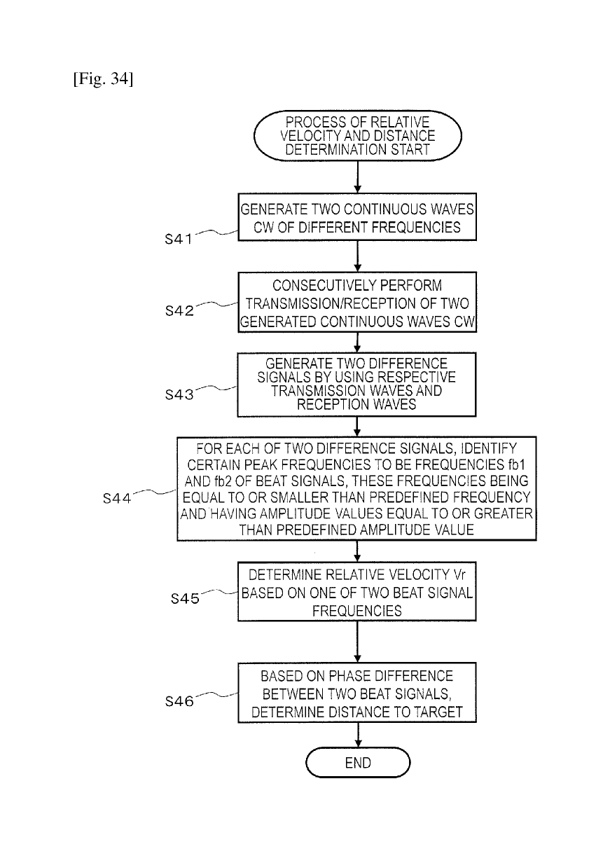

Next, with reference to FIG. 34, a procedure of processing to be performed by the object detection apparatus of the radar system 10 will be described. The construction of the multicopter 1 including the radar system 10 is as shown in FIG. 1 through FIG. 14, for example.

The example below will illustrate a case where continuous waves CW are transmitted at two different frequencies fp1 and fp2 (fp1<fp2), and the phase information of each reflected wave is utilized to respectively detect a distance between a target and the multicopter 1.

FIG. 34 is a flowchart showing a procedure of processing of relative velocity and distance determination according to the present embodiment based on separation between a reflected wave originating from a rotor 5 and a target-originated reflected wave.

At step S41, the triangular wave/CW wave generation circuit 221 generates two continuous waves CW of frequencies which are slightly apart, i.e., frequencies fp1 and fp2.

At step S42, the transmission antenna TA and the reception antennas RA perform transmission/reception of the generated series of continuous waves CW. Note that the process of step S41 and the process of step S42 are to be performed in parallel fashion by the triangular wave/CW wave generation circuit 221 and the antenna TA/RA, rather than step S42 following only after completion of step S41.

At step S43, each mixer 224 generates a difference signal by using each transmission wave and each reception wave, whereby two difference signals are obtained. Each reception wave is inclusive of a reception wave emanating from a rotor and a reception wave emanating from a target. Therefore, next, a process of identifying frequencies to be utilized as the beat signals is performed. Note that the process of step S41, the process of step S42, and the process of step 43 are to be performed in parallel fashion by the triangular wave/CW wave generation circuit 221, the antenna TA/RA, and the mixers 224, rather than step S42 following only after completion of step S41, or step S43 following only after completion of step S42.

At step S44, for each of the two difference signals, the object detection apparatus 40 identifies certain peak frequencies to be frequencies fb1 and fb2 of beat signals, such that these frequencies are equal to or smaller than a frequency which is predefined as a threshold value and yet they have amplitude values which are equal to or greater than a predetermined amplitude value, and that the difference between the two frequencies is equal to or smaller than a predetermined value. Although the two difference signals may also include beat signals having frequencies which are equal to or greater than the threshold value, these are beat signals originating from reflected waves reflecting off a rotor, etc., and therefore are excluded from the following processes. If a plurality of targets having different relative velocities with respect to the radar system 10 exist within the field of view of the radar system, a plurality of pairs of peaks, such that the frequency difference between the two is equal to or smaller than a predetermined value, exist. In that case, the following processes are to be performed for each such pair of beat signals.

At step S45, based on one of the two beat signal frequencies identified, the reception intensity calculation section 232 detects a relative velocity. The reception intensity calculation section 232 calculates the relative velocity according to Vr=fb1·c/2·fp1, for example. Note that a relative velocity may be calculated by utilizing each of the two beat signal frequencies, which will allow the reception intensity calculation section 232 to verify whether they match or not, thus enhancing the precision of relative velocity calculation.

At step S46, the reception intensity calculation section 232 determines a phase difference Δφ between the two beat signals fb1 and fb2, and determines a distance R=c·Δφ/4π(fp2−fp1) to the target.

Through the above processes, the relative velocity and distance to a target can be detected.

Note that continuous waves CW may be transmitted at N different frequencies (where N is 3 or more), and phase information of the respective reflected wave, distances to plural targets which are of the same relative velocity but at different positions may be detected.

Thus, Embodiments 1 to 4 have been described above. The unmanned multicopter 1 according to each embodiment may further include another radar system in addition to the radar system 10. For example, the unmanned multicopter 1 may further include a radar system which has a detection range below or above the multicopter body. In the case a radar system is provided immediately under the multicopter body, that radar system has a function of monitoring lower directions at landing, and upon detecting any object at a position higher than the ground, causing the unmanned multicopter 1 to move through the air to look for a location for landing. When a radar system is provided immediately over the central housing 2, that radar system monitors upper directions at takeoff, and upon confirming absence of any obstacles, a takeoff will be made.

The radar system for monitoring upper directions and/or lower directions includes one transmission element and one reception antenna element each, and by utilizing them, detects whether any obstacle exists immediately over and/or immediately under the unmanned multicopter 1. That radar system may be based on ultrasonic radar. However, in order to reduce the influences of sounds which are generated by the rotors 5, it is preferably attached immediately over and/or immediately under the central housing 2 of the unmanned multicopter 1.

### 5. Example Applications

Hereinafter, example applications of unmanned multicopters performing at least one of the processes of Embodiments 1 to 3 above will be described.

### 5.1. Unmanned Multicopter Having a Camera Mounted Thereon

FIG. 35 is an outer perspective view of an unmanned multicopter 501 according to an example application of the present disclosure. The unmanned multicopter 501 consists of the unmanned multicopter 1 with a camera 502 attached thereto. Other than the addition of the camera 502, it is similar in appearance to the unmanned multicopter 1. Hereinafter, constituent elements of the unmanned multicopter 501 corresponding to the constituent elements of the unmanned multicopter 1 will be denoted by corresponding reference numerals, while the following description will be directed only to the differences in construction and operation.

The camera 502 is installed below the central housing 2 (near immediately below the radar system 10), for example. For example, a gimbal 503 may be used to support the camera 502. A gimbal is a kind of rotation platform for allowing an object to rotate around one axis. A multi-axis gimbal in which axes are orthogonal to each other may be installed.

It is assumed in the present specification that the radar system 10 is mainly oriented in the heading of the unmanned multicopter. While its orientation is adjusted by the gimbal 503, the camera 502 is able to shoot a video in the heading. For professional applications, the camera 502 may be used to do a situation check on a construction site, any large-sized structure, or the like, for example.

The camera 502 is connected to the flight controller 11 shown in FIG. 3, and controlled by the flight controller 11. For example, if the reception module 13 receives from the operator an instruction to perform video shooting, the reception module 13 sends that instruction to the flight controller 11. In accordance with the instruction, the flight controller 11 determines the shooting direction of the camera 502, and outputs an instruction signal for the camera 502 to perform video shooting.

In professional applications, for prevention of accidents, delays in the construction schedule, etc., it is necessary to minimize collision accidents due to mismanipulations or the like. To this end, it would be effective to recognize obstacles (targets) by using the radar system 10. Prescribing a wider detection range for the radar system 10 will allow more reliable detection of targets. For example, six transmission antennas TA and/or reception antennas RA may be placed at equal intervals so as to be 60 degrees apart. By designing each with a monitored field of about 70 degrees, it becomes possible to identify targets in all azimuths around the unmanned multicopter 501. In FIG. 35, six reception antenna elements RA are illustrated as an example. Target detection can be achieved in the manner described in any of the above-described embodiments.

Note that there is a class of unmanned multicopters that include ultrasonic sensors. An ultrasonic sensor is used to measure a distance to a target based on the amount of time from when an acoustic wave is emitted to when the acoustic wave returns. However, an ultrasonic sensor may be affected by the flows of winds caused by the rotors and the wind noise. Moreover, its detectable distance is several meters or less. Therefore, the radar system 10 allows a target to be detected more reliably than in a multicopter equipped with a collision prevention mechanism in which ultrasonic sensors are used.

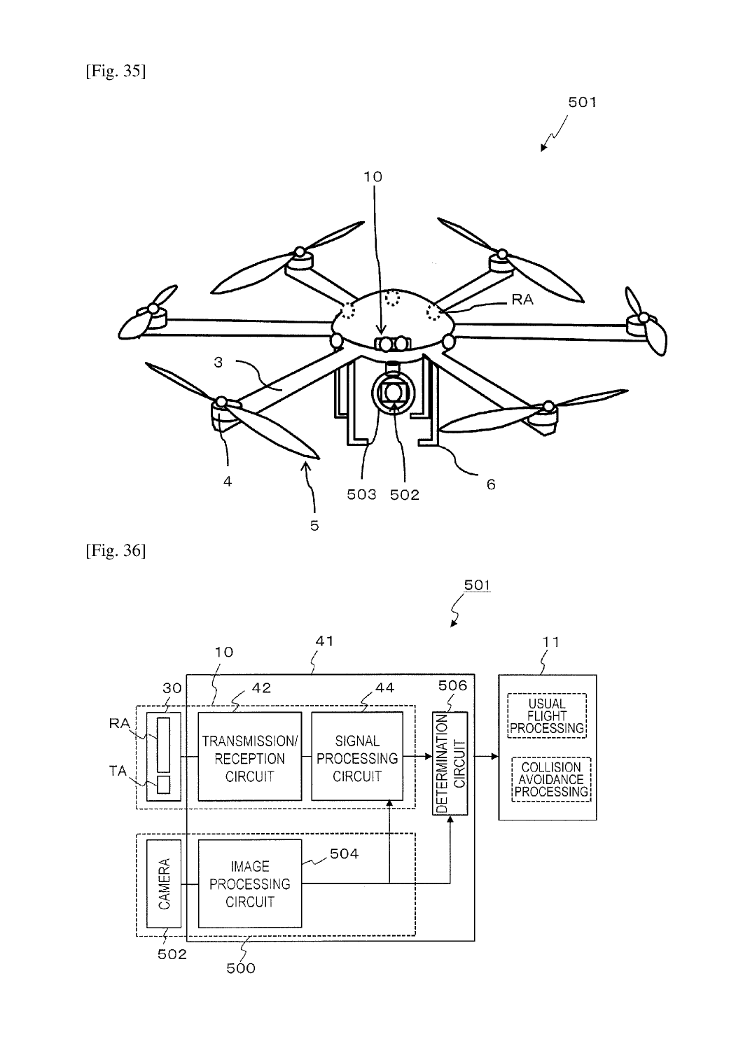

FIG. 36 shows a construction for an object detection apparatus 41 according to the present example application. The unmanned multicopter 501 shown in FIG. 36 includes the radar system 10 and a camera system 500, and controls flight of the unmanned multicopter 501 by utilizing results of detection by the radar system 10 and results of video recognition by the camera system 500.

The construction of the radar system 10 is as has been described above. In the present example application, the transmission antennas TA and the reception antennas RA are placed on the upper face, side face, lower part of the central housing 2, but above the camera 502.

The camera system 500 includes a camera 502 and an image processing circuit 504 which processes an image or video that is acquired by the camera 50.

The unmanned multicopter 501 according to the present example application includes an object detection apparatus 41 and a flight controller 11 connected to the object detection apparatus 41, the object detection apparatus 41 including a determination circuit 506, the radar system 10, and the camera system 500. The determination circuit 506 of the object detection apparatus 41 determines a probability of collision, by using target information which is acquired with the radar system 10 and video information which is identified through an image processing of the video from the camera 502 applied by the image processing circuit 504.

For example, the determination circuit 506 continually monitors distance to a target and relative velocity with respect to the target as acquired by the radar system 10, and also the target size which is recognized by the camera 502. Then, the determination circuit 506 compares the velocity of travel (against the ground) of the unmanned multicopter 501 itself as well as its azimuth as acquired by the signal processing circuit 44 against the relative velocity with respect to and the azimuth of the target, thereby determining whether the target is a stationary target or a moving target.

For a stationary target, the determination circuit 506 calculates three-dimensional coordinates based on the information which is acquired by the radar system 10 and the camera 502, and determines a probability of collision by referring to the three-dimensional coordinates and to the direction of movement and velocity of travel (which together will be referred to as the velocity vector) of the unmanned multicopter 501 itself. For a moving target, the determination circuit 506 calculates not only three-dimensional coordinates but also a velocity vector thereof, and determines a probability of collision by using the three-dimensional coordinates and velocity vector of the unmanned multicopter 501 itself.

For both of a stationary target and a moving target, the three-dimensional coordinates and velocity vector are to be updated every predetermined time interval; for a moving target, though, updates may be allowed to occur more often. As for the probability of collision determination, the determination circuit 506 simultaneously considers various factors in determining a probability of collision with the target, such as: whether the distance to the target is shortening or not; whether the unmanned multicopter 501 and the target are coming closer together, as is known from their changing relative velocity; whether or not it will be possible to avoid a target of the detected size given the flight performance (flight speed) of the unmanned multicopter 501; and so on. Examples of other processes will be described in the next item 5.2.

Note that, without utilizing a video that has been taken, the determination circuit 506 may determine a probability of collision by utilizing a distance to the target and a relative velocity of the target as acquired by the radar system 10.

If a value indicating the probability with which a collision may occur exceeds a predefined reference value, the flight controller 11 of the unmanned multicopter 501 performs collision avoidance processing; if it is equal to or less than the reference value, the usual flight processing is continued. The collision avoidance processing interrupts the processing by the microcontroller 20 of the flight controller 11, so that it is executed with the highest priority. Examples of collision avoidance processing may be, for example: a process of continuously monitoring changes in the target position to predict a position at which the target will arrive and get away from that position at the maximum velocity; and a process of gradually beginning to change the flight path even while being sufficiently distant from such a position. The microcontroller 20 may determine which of these processes is more appropriate in accordance with the situation during flight, and execute that process.

The radar system 10 may further include a lower-direction monitoring radar which is provided below the arm 3 to monitor lower directions, and an upper-direction monitoring radar which is provided above the central housing to monitor upper directions. Furthermore, it may include four antennas TA/RA each of which is capable of monitoring a range of about 100 degrees on the XY plane, or three antennas TA/RA each of which is capable of monitoring a range of about 130 degrees on the XY plane. The monitorable ranges of any two adjacent radars along the circumferential direction may partially overlap along the circumferential direction.

The aforementioned unmanned multicopter 1 or 501 may be used for delivering an article for delivery. By using the plurality of legs 6, or by separately providing a carrier in addition to the legs 6, the article for delivery can be held by it in a detachable manner.

For example, an article for delivery may be mounted to the unmanned multicopter 1 at a pick-up station of articles for delivery; the unmanned multicopter 1 may fly off; and the unmanned multicopter 1 may continue flight to a destination of delivery by using output signals from the radar system 10 and/or the GPS module 12. Once arriving near the destination, the unmanned multicopter 1 may hover in the air above the destination, or decelerate to a predetermined velocity or below. Thereafter, as the recipient receives the article for delivery, or as the flight controller 11 disengages the fixtures (off the article for delivery) in response to an instruction from the operator, the article for delivery becomes released. Thereafter, the unmanned multicopter 1 may fly to the pick-up station of articles for delivery or to a next destination, by using output signals from the radar system 10 and/or the GPS module 12.

When lacking a camera, the unmanned multicopter 1 is especially suitable for delivering an article for delivery in areas where individual houses exist, such as a residential area. The absence of cameras guarantees that no images will be taken within the premises of the individual, thus posing a very low possibility of privacy invasion.

### 5.2. Autonomous Flight and Collision Avoidance

The unmanned multicopter 1 will be taken for example.

The unmanned multicopter 1 has a function of performing autonomous flight to a designated destination in accordance with a GPS signal which is output from the GPS module 12, and also a function of, upon detecting an obstacle with the radar system 10 during flight, autonomously performing an avoiding action. These functions are achieved as the microcontroller 20 of the flight controller 11 executes a computer program to perform a process corresponding to each function.

The radar system 10 may provide angular resolution not only with respect to horizontal directions, but also with respect to up-down directions; in that case, when making an autonomous avoiding action, the direction of flight can also be altered in terms of up-down directions. For example, electric wires, a long and large bridge, or the like may lie across in front, in which case the flight controller 11 may not be able to find an alternative route in any horizontal direction. In such cases, the flight controller 11 may instruct the radar system 10 to compare intensities among the reflection signals of radio waves which have been radiated from the transmission antennas TA above and below. Then, the flight controller 11 may make an estimation as to up-down distribution, and determine whether any alternative route exists while also taking up-down directions into consideration.

In the case where each transmission antenna TA has only a single transmission antenna element, the radar system 10 does not provide any resolution with respect to up-down directions, thus being unable to find an alternative route.

Accordingly, signal waves may be transmitted from the transmission antenna element while the multicopter body of the unmanned multicopter 1 is inclined forward or backward, or while its altitude is changed, etc., and changes in signal intensity may be checked in order to find a distribution of obstacles with respect to up-down directions. As a result, a flight path that enables avoidance may be found. Note that this method will also be useful when the radar does provide resolution with respect to up-down directions.

When the radar system 10 captures a target, the relative velocity information between itself and the target can be acquired. For example, when an FWCM radar of the 76.5 GHz band is used, a relative velocity of about 2 m/s or above can be detected. A probability of collision can be evaluated by taking the relative velocity information and the distance information together.

When the value indicating probability of collision exceeds a predefined reference value (i.e., being non-negligible), the radar system 10 may attempt radar detection of that target several times while detecting the azimuth of the target, in order to determine the azimuth in which the target is moving; this provides an enhanced accuracy of probability of collision evaluation. In order to attain an even higher accuracy, the radar system 10 may radiate a transmission wave twice at a predetermined time interval, and only if a reflected wave is detected for both of the two times, the signal(s) may be treated as true. Otherwise, it may be decided that a transmission wave from another multicopter has mixed. The twice-radiated transmission waves may be a frequency modulated continuous wave FMCW and a continuous wave CW, for example.

Regarding any large-sized stationary structure that may become an obstacle during the flight of the unmanned multicopter 1, its position information may be internally retained in advance, or acquired through a communication means. This allows the position and azimuth of the unmanned multicopter 1 itself to be confirmed, and also allows to avoid a collision. By internalizing information concerning the distribution of stationary structures (distribution information) in advance, or occasionally acquiring it with a communication means, the radar system 10 is able to determine the need for radar monitoring on the basis of the distribution information, and perform monitoring only when it is necessary.

Usually, the approximate location of the destination and a flight path thereto are set in advance to the unmanned multicopter 1. While checking its own position via the GPS or the like, the multicopter flies along this flight path. In the meantime, the microcontroller 20 of the flight controller 11 puts the radar system 10 on pause in order to reduce power consumption. Then, upon arrival near the destination, the microcontroller 20 may be restored from pause, and the radar may confirm the detailed location of the destination or any unexpected obstacle. A similar pause control would also be applicable to any monitoring device other than the radar that is mounted in the unmanned multicopter 1, e.g., a camera, an imaging device, or the like. Such pause control is applicable not only while on the flight path to the destination, but also in any other situation while it is clear that the radar system 10 or the like will not be utilized. As a result, power consumption can be reduced.

By using the unmanned multicopter 1, it would be possible to operate an article delivery business. For use in such a purpose, the unmanned multicopter 1 would include a carrier with which an article is to be held and carried to a destination. When requested to deliver an article, a delivering entity may mount the article onto the unmanned multicopter 1 at an article delivery base, and launch the unmanned multicopter 1 for the destination. By virtue of the above-described autonomous flight function and collision avoidance function, the unmanned multicopter 1 will arrive at the destination, release the article from the carrier there, and fly off to the article delivery base from which it had departed, or to another delivery base or a maintenance base for the multicopter 1. The article delivery base may also serve as the maintenance base.

The operation of releasing the article from the carrier is to be automatically performed upon arriving at the destination. Alternatively, it may be achieved through remote control by the delivering entity, or via manual operation by utilizing a handheld electronic device that belongs to the recipient. The unmanned multicopter 1 may include a plurality of carriers which are capable of performing release operations independently of one another. In this case, the unmanned multicopter 1 may be launched from the article delivery base, consecutively visit a plurality of destinations while releasing an article from a carrier at each destination to accomplish delivery, and thereafter return. Since the unmanned multicopter 1 according to the present disclosure has the autonomous flight function and the collision avoidance function, it is unlikely to cause an accident in the above series of tasks. In order to run a delivery business in an environment where the positioning of space-occupying structures may change from day to day, e.g., urban areas, the unmanned multicopter 1 according to the present disclosure will be especially suitable.

Thus, embodiments and various example applications of the present invention have been described.

The above embodiments have illustrated processes where signal waves are received by using an array antenna to identify the azimuth of a target-originated reflected wave. However, in the case where azimuth identification is achieved through another process, there is no need to provide a direction-of-arrival estimation unit 48 (FIG. 5) which performs complicated processing, and it is also unnecessary to use an array antenna for signal wave reception.

The gyro sensor 23a and the magnetic sensor 23d (FIG. 4) can be utilized for an azimuth identifying process, for example. Specifically, by using an output signal from the magnetic sensor 23d (FIG. 4), the flight controller 11 will be able to identify a heading direction (azimuth) in which the unmanned multicopter 1 travels. Furthermore, by using an output signal from the gyro sensor 23a, the flight controller 11 will be able to identify the attitude of the unmanned multicopter 1, i.e., the orientation of each reception antenna RA. Furthermore, when a reception antenna RA has received a signal, the flight controller 11 may swing the unmanned multicopter 1 right or left in the XY plane, in order to identify positions at which such a signal wave is received and positions at which such a signal wave is not received. Thus, the flight controller 11 is able to know the direction of arrival of a reception wave.

The present disclosure is applicable to an unmanned multicopter having a radar system mounted therein. It is also applicable to a large-sized (manned) multicopter which is capable of flying with a person riding therein.

What is claimed is:

1. A multicopter comprising:
a central housing;
three or more rotors placed around the central housing;
a plurality of motors to respectively rotate the three or more rotors; and
a radar system to transmit and receive a signal wave and detect a target by using the signal wave, wherein,
the radar system includes
at least one antenna element and
an object detection apparatus to transmit the signal wave, and perform a target detecting process by using the signal wave as received by the at least one antenna element;
a first antenna element among the at least one antenna element is in a position to receive a rotor-originated reflected wave, the rotor-originated reflected wave being the signal wave transmitted during flight of the multicopter and having been reflected off a first rotor among the three or more rotors;
the signal wave as received by the at least one antenna element is inclusive of a target-originated reflected wave reflected off a target and a rotor-originated reflected wave, the rotor-originated reflected wave being the signal wave transmitted during flight of the multicopter and having been reflected off a first rotor among the three or more rotors; and
the object detection apparatus determines whether or not a frequency band satisfying a predefined condition for identifying a frequency peak is contained in a frequency spectrum of the signal wave as received by the at least one antenna element, and determines a peak of the frequency band satisfying the predefined condition to be a frequency of the target-originated reflected wave.

2. The multicopter of claim 1, wherein, as the predefined condition, the object detection apparatus determines whether or not a frequency band which satisfies a condition of being within a certain frequency span and yet having a predetermined intensity or greater is contained in the frequency spectrum of the signal wave.

3. The multicopter of claim 1, wherein,
a highest value of frequency of the rotor-originated reflected wave increases or decreases in synchronization with rotation of the first rotor; and
in determining whether or not the frequency of the signal wave satisfies the predefined condition for identifying a frequency peak, the object detection apparatus uses the signal wave existing when the highest value of frequency of the rotor-originated reflected wave is substantially smallest.

4. A multicopter comprising:
a central housing;
three or more rotors placed around the central housing;
a plurality of motors to respectively rotate the three or more rotors; and
a radar system to transmit and receive a signal wave and detect a target by using the signal wave, wherein,
the radar system includes
at least one antenna element and
an object detection apparatus to transmit the signal wave, and perform a target detecting process by using the signal wave as received by the at least one antenna element;
a first antenna element among the at least one antenna element is in a position to receive a rotor-originated reflected wave, the rotor-originated reflected wave being the signal wave transmitted during flight of the multicopter and having been reflected off a first rotor among the three or more rotors; and
the object detection apparatus
transmits a plurality of signal waves at predetermined time intervals,
receives a plurality of rotor-originated reflected waves, the plurality of rotor-originated reflected waves respectively being the plurality of signal waves having been reflected off the first rotor,
identifies a moment at which an angle or solid angle as the first rotor is viewed from the at least one antenna element becomes equal to or smaller than a predetermined value, by utilizing the plurality of reflected waves, and
estimates a next or any subsequent moment at which the angle or solid angle is to become equal to or smaller than the predetermined value.

5. The multicopter of claim 4, wherein
the object detection apparatus includes:
a transmission/reception circuit to generate the plurality of signal waves and generate a plurality of beat signals by using the plurality of signal waves and a plurality of reception signals, each beat signal taking varying frequencies including a highest frequency; and
a signal processing circuit to identify a moment associated with a smallest one among the highest frequencies of the plurality of beat signals to be a moment at which the angle or solid angle becomes equal to or smaller than the predetermined value.

6. The multicopter of claim 5, wherein,
the transmission/reception circuit generates two or more kinds of signal waves with different frequency sweep rates, and generates the plurality of beat signals by using at least one kind of signal wave among the two or more kinds of signal waves; and
a frequency sweep rate of the at least one kind of signal wave is zero, or smaller than a sweep rate of any other kind of signal wave.

7. The multicopter of claim 5, wherein, in estimating the next or any subsequent moment at which the angle or solid angle is to become equal to or smaller than the predetermined value, the signal processing circuit utilizes:
the moment at which the angle or solid angle becomes equal to or smaller than the predetermined value; and
a number of revolutions of the first rotor as identified based on a time interval between a moment associated with a smallest one among the highest frequencies of the plurality of beat signals and a moment associated with a largest one among the highest frequencies of the plurality of beat signals.

8. The multicopter of claim 5, wherein the signal processing circuit identifies a frequency component of the rotor-originated reflected wave from among frequency components of the plurality of beat signals, and utilizes the identified frequency component in identifying the moment at which the angle or solid angle becomes equal to or smaller than the predetermined value.

9. The multicopter of claim 5, further comprising:
a plurality of control units to control rotation of the plurality of motors; and
a flight controller to communicate with each of the plurality of control units, wherein,
from a first control unit to control rotation of the motor for the first rotor, the flight controller acquires information of a number of revolutions of the motor; and
in estimating the next or any subsequent moment at which the angle or solid angle is to become equal to or smaller than the predetermined value, the signal processing circuit utilizes the number of revolutions of the first rotor and the moment at which the angle or solid angle becomes equal to or smaller than the predetermined value.

10. The multicopter of claim 5, wherein the transmission/reception circuit generates a continuous wave (CW) or a continuous wave (FMCW) whose frequency is modulated.

11. The multicopter of claim 4, wherein,
the at least one antenna element comprises a plurality of antenna elements in a one-dimensional array or a two-dimensional array; and
in identifying the moment at which the angle or solid angle as the first rotor is viewed from the at least one antenna element becomes equal to or smaller than the predetermined value, and in estimating the next or any subsequent moment at which the angle or solid angle is to become equal to or smaller than the predetermined value, the object detection apparatus uses the plurality of reflected waves.

12. The multicopter of claim 7, wherein,
the at least one antenna element comprises a plurality of antenna elements in a one-dimensional array or a two-dimensional array; and
in identifying the moment at which the angle or solid angle as the first rotor is viewed from the at least one antenna element becomes equal to or smaller than the predetermined value, and in estimating the next or any subsequent moment at which the angle or solid angle is to become equal to or smaller than the predetermined value, the object detection apparatus uses the plurality of reflected waves.

13. A multicopter comprising:
a central housing;
three or more rotors placed around the central housing;
a plurality of motors to respectively rotate the three or more rotors; and
a radar system to detect a target by FMCW method, wherein,
the radar system includes
at least one antenna element and
an object detection apparatus to transmit a signal wave while modulating the signal wave, receive the signal wave with the at least one antenna element, and perform a target detecting process by using the signal wave;
the at least one antenna element is in a position to receive a rotor-originated reflected wave, the rotor-originated reflected wave being the signal wave transmitted during flight of the multicopter and having been reflected off a first rotor among the three or more rotors;
the signal wave as received by the at least one antenna element is inclusive of
a target-originated reflected wave reflected off a target and
a rotor-originated reflected wave, the rotor-originated reflected wave being the signal wave transmitted during flight of the multicopter and having been reflected off a first rotor among the three or more rotors;
the object detection apparatus includes
a memory to retain information of a beat frequency Δfp to occur as the signal wave reciprocates to and from the first rotor and a beat frequency Δft as the signal wave reciprocates to and from a target located in a minimum design detection range of the radar system, and
a calculation circuit by using a beat signal generated from the transmitted signal wave and the received signal wave, to determine a frequency distribution of the beat signal; and
among frequency components of the beat signal, the calculation circuit identifies a frequency component which is greater than the beat frequency Δfp and smaller than the beat frequency Δft, or a frequency component which is greater than the beat frequency Δft, to be a frequency component of the target-originated reflected wave.

14. The multicopter of claim 13, wherein, within a monitored field of the at least one antenna element, the motor for the first rotor rotates the first rotor in a direction of approaching the at least one antenna element.

15. The multicopter of claim 13, wherein,
by using an UP beat signal generated from the signal wave transmitted and the signal wave received in an UP beat period, the calculation circuit identifies, among frequency components of the UP beat signal, a frequency component which is greater than the beat frequency Δfp and smaller than the beat frequency Δft to be the frequency component of the target-originated reflected wave.

16. The multicopter of claim 13, wherein,
by using a DOWN beat signal generated from the signal wave transmitted and the signal wave received in a DOWN beat period, the calculation circuit identifies, among frequency components of the DOWN beat signal, a frequency component which is greater than the beat frequency Δft to be the frequency component of the target-originated reflected wave.

17. The multicopter of claim 14, wherein,
the three or more rotors further include a second rotor which is adjacent to the first rotor and rotates in an opposite direction to the first rotor; and
the at least one antenna element is in a position to receive respective rotor-originated reflected waves reflected off the first rotor and the second rotor.

18. A multicopter comprising:
a central housing;
three or more rotors placed around the central housing;
a plurality of motors to respectively rotate the three or more rotors; and
a radar system to transmit and receive a signal wave and detect a target by using the signal wave, wherein,
the radar system includes
at least one antenna element and
an object detection apparatus to transmit the signal wave, and perform a target detecting process by using the signal wave as received by the at least one antenna element;
a first antenna element among the at least one antenna element is in a position to receive a rotor-originated reflected wave, the rotor-originated reflected wave being the signal wave transmitted during flight of the multicopter and having been reflected off a first rotor among the three or more rotors; and
the object detection apparatus transmits a signal wave of at least one frequency, and receives a rotor-originated first reflected wave and a target-originated second reflected wave, the rotor-originated first reflected wave being the signal wave having been reflected off the first rotor, and the target-originated second reflected wave being the signal wave having been reflected off a target;
within beat signals which are obtained from the transmitted signal wave and the first reflected wave and second reflected wave, identify a frequency of a peak which is at a predefined frequency or below and which has an amplitude value equal to or greater than a predefined amplitude value to be a beat signal frequency; and
calculate a relative velocity between the radar system and the target based on the beat signal frequency.

19. A multicopter comprising:
a central housing;
a plurality of rotors placed around the central housing;
a plurality of motors to respectively rotate the plurality of rotors; and
a radar system to transmit and receive a signal wave and detect a target by using the signal wave, wherein,
the radar system includes
at least one antenna element and
an object detection apparatus to transmit the signal wave, and perform a target detecting process by using the signal wave as received by the at least one antenna element;
a first antenna element among the at least one antenna element is in a position to receive a rotor-originated reflected wave, the rotor-originated reflected wave being the signal wave transmitted during flight of the multicopter and having been reflected off a first rotor among the plurality of rotors; and
the object detection apparatus
transmits a signal wave which continues for a certain period while undergoing a frequency modulation of frequency increase or decrease,
identifies a frequency of a beat signal obtained from the signal wave and a reflected wave of the signal wave by relying on the frequency of a peak having a frequency which is equal to or greater than a predefined frequency, and
calculates a distance between the radar system and the target based on the frequency of the beat signal, wherein,
the predefined frequency is greater than RWm/(CTm), where Tm is a duration of the certain period, R is a lower limit of detection distance of the radar system, Wm is a modulation width of the frequency modulation, and C is the velocity of light, and
the lower limit R is greater than a distance from the at least one antenna element to the first rotor, and equal to or less than ten times a largest diameter of the multicopter.

20. The multicopter of claim 19, wherein,
plural instances of transmission of the signal wave are performed; and
the object detection apparatus
identifies respective frequencies of a plurality of beat signals resulting from the plural instances of transmission,
selects a pair of beat signals such that a difference between frequencies thereof is smaller than a predetermined value, and
calculates a relative velocity between the radar system and the target by utilizing a phase difference between the beat signals in the selected pair of beat signals.
